(19) United States
(12) Patent Application Publication
(10) Pub. No.: US 2020/0311031 A1
(43) Pub. Date: Oct. 1, 2020

(54) User Environment, Multi-user Collaborative Data Governance Method and Computer-Readable Storage Medium

(71) Applicant: China Electronics Technology Group Corporation Information Science Academy, Beijing (CN)

(72) Inventor: Siew Yong SIM-TANG, Morgan Hill, CA (US)

(73) Assignee: China Electronics Technology Group Corporation Information Science Academy, Beijing (CN)

(21) Appl. No.: 16/787,599

(22) Filed: Feb. 11, 2020

(30) Foreign Application Priority Data
Mar. 25, 2019 (CN) CN201910227237.6
Oct. 14, 2019 (CN) CN201910974066.3
Oct. 14, 2019 (CN) CN201910974971.9

(51) Int. Cl. G06F 16/176; G06F 16/182; G06Q 10/10

(52) U.S. Cl. CPC G06F 16/1774; G06Q 10/101; G06F 16/1827

(57) ABSTRACT

A user environment for a multi-user collaborative data governance system. The user-environment includes one or more data connectors, one or more data catalogs, one or more datasets, and a user environment service. A multi-user collaborative data governance method implemented on one or more processors includes associating each of one or more datasets with a data item from one of one or more data connectors and associating each of the one or more datasets with a subscribed data item subscribed from one of one or more data catalogs. Further steps are associating each of the one or more datasets with a published dataset in one of the one or more data catalogs through publishing the dataset on the data catalog and associating each of one or more collaborators with one or more datasets with usage permission.

### CROSS-REFERENCE TO RELATED APPLICATIONS

The application claims priority of Chinese patent application CN201910227237.6, filed on Mar. 25, 2019, Chinese patent application CN201910974066.3, filed on Oct. 14, 2019, and Chinese patent application CN201910974971.9, filed on Oct. 14, 2019, the entire contents of each of which are incorporated herein by reference.

### TECHNICAL FIELD

The field of the present disclosure relates to data asset management and data processing.

### BACKGROUND

In many countries with relatively new IT infrastructures, while the operation of most government departments may be digitized, their data are typically not shared or exchanged. This data silo situation not only results in low productivity within each organization, but also causes much inconvenience to the citizens. For every government inquiry or ask, the people may have to visit multiple government offices to get relevant certifications. Also, private entities that create application services for the public cannot effectively implement their product features without some government data. Research institutions have no effective or efficient means to gather and analyze data from multiple government sources for analysis.

In order to prevent illegal use of data and to protect the privacy of citizens, data sharing must be handled with special care. Today, requesting data from many government departments is very challenging. Most government departments are typically burdened by clumsy approval processes relying on paper documents. Once data access is approved, a manual IT process is required to filter out and transform sensitive data for security and privacy control reasons. The dated data are then placed in a shared location or converted into portable form for download. Due to the high cost of IT, and security and privacy concerns, government organizations are usually reluctant to share their data.

Many developing and developed Asian cities are now working on connected government smart city projects to connect municipal government departments, to enable the latter to securely share data. Smart city for connected government project typically includes a data hosting service provider. Each government organization sends its sharable data to the data hosting service provider. The data hosting service provider is responsible for managing the data assets, building data catalog, instituting digital data subscription approval process, enforcing security and privacy control to data access, and auditing all data usages.

However, to date, many government departments are still reluctant to hand over their data to data hosting service providers, because these providers are unable to effectively manage data security and privacy, and monitor data usage. Once the data have been handed over to the data hosting service providers, the government departments fear they would lose control over how the data can be used.

Municipal government data hosting service provider needs a multi-tenant platform where all government organizations can self-manage their data, set data access security and privacy control rules, share data through a secured publish and subscribe mechanism. However, these service providers are not able to find suitable solutions on the market. Today, most of the data hosting service providers simply provide a government data directory for private or public browsing. The application for accessing government data is still a manual process. This process may involve application review by the hosting data service provider as well as the data owning organization. Once approved, the data can be downloaded. Such a method is not efficient. Also, downloadable data are mostly statistical summaries rather than the actual data, while real-time data are virtually never available. Consequently, the issues and concerns underlying such data remain frustratingly out of reach to those who seek to devise solutions to address them.

In the Internet era, clinical studies still rely heavily on paper documents and mail exchanges. A clinical study involves protocol design, participant screening, protocol review and execution. The results are forwarded to and processed by medical investigators and corporate or government sponsors. If successful, the final results are submitted to regulatory and oversight agencies for inspection and approval before commercialization.

The problem with this legacy process is that the entire undertaking, from the data collected, to the analytical methods, to the final approval steps, are not fully transparent to all participants. There is also no easy or systematic way to infuse data from other relevant studies to look at potential side-effects or benefits, so as to develop a more holistic understanding of the results. This problem is far from unique to clinical trials. While some research or studies may involve participants submitting data to a website, in many cases, such website would be taken offline once the research has been completed, rendering these data inaccessible to future researchers and potential collaborators.

There have been attempts in recent years to build collaborative clinical trial study networks where data can be shared. However, security and privacy management are major concerns. At present, there is no product dedicated to support such application on the market.

Aside from clinical studies, universities and research institutes have also generated enormous quantities of biological and other scientific data. Many research groups publish a portion of their research results online for sharing. However, it is not always easy for researchers in certain domains to find data that are relevant to them, as they are scattered all over the Internet, while legacy publishers still dominate the medium, limiting the means by which researchers are able to publish and share their data. There does not exist a collaborative network where data owners can control the security and privacy of their own data for the purpose of sharing.

Current data asset management and data sharing products mostly evolved from Business Intelligence (BI) products or data warehouse ETL (Extract, Transform, and Load) products. These conventional products are designed for enterprise use with centralized data control where there is an IT department responsible for managing all data. Two such product examples are a TIBCO Data Virtualization system available from Tibco Software Inc., and a DENODO PLATFORM with data virtualization available from Denodo Technologies, Inc.

As illustrated in FIG. 1, conventional products (0100) involve IT administrators (0101) first process corporate data by going through extraction, cleaning, and transformation to create curated data. IT administrators then connect the curated data source (0102-a, 0102-b, 0102-c) to the platform for management purposes. In the platform, data source (0121-a, 0121-b, 0121-c) objects are logical entities created to manage the real data source (0102-a, 0102-b, 0102-c). IT administrators then build and manage a static data directory (also known as a data catalog 0105) which contains a list of all the data sources connected to the platform.

Some of the conventional solutions also support Virtual Data sources (0126, 0127). Virtual data sources may combine data from multiple data sources or may present a subset of a real data source. Virtual data server (0129-d, 0129-e) can be created to serve the Virtual data source (0126, 0127). Some products, such as Tibco Data Virtualization solution, refer to these virtual data sources (0126, 0127) as virtual data marts. Virtual data sources are also listed in the data directory (0105).

IT administrator then manually create Virtual Data Servers (0129-a, 0129-b, 0129-c, 0129-d, 0129-e) to serve each of the data sources (0121-a, 0121-b, 0121-c, 0126, 0127) in the directory. For each Virtual Data Server (0129-a, 0129-b, 0129-c, 0129-d, 0129-e), the IT administrator would create granular access control policies for users and user groups. For example, for Virtual Data Server (0129-a) which maps to Data Source (0121-a), the IT administrator can configure which data user or data user group can access which row and column of the data, and which data columns must be masked for which users or user groups. A Virtual Data Server enforces the access control policies for all data users accessing its corresponding data source.

Using conventional solutions, data users (1030) can browse data directory (0131) to find a data source (0121-a, 0121-b, 0121-c, 0126, or 0127) and their Virtual Data Server information (0129-a, 0129-b, 0129-c, 0129-d, or 0129-e). Data users then connect to the Virtual Data Servers (0129-a, 0129-b, 0129-c, 0129-d, or 0129-e) to request data. The Virtual Data Servers (0129-a, 0129-b, 0129-c, 0129-d, or 0129-e) retrieve data from the real data sources (0102-a, 0102-b, 0102-c) through the data source objects (0121-a, 0121-b, 0121-c, 0126, or 0127), then convert the data according to the requester's credential and the granular access control policies before returning data to the requester.

The problem with these conventional solutions is that all data and the administration of the data usage (security and privacy control) are managed and controlled by a centralized IT organization. Distributed groups of participants cannot manage their own data sources, or perform their own cleaning and transformation, or control the sharing of their data sources, or set their own security and privacy control rules. As a result, these prior solutions are not practical for the above-mentioned present-day use cases, such as those that must be addressed in a connected government smart city project. Therefore, most government organizations are still not comfortable handing over data to the IT administrators of the data hosting service providers.

### SUMMARY

Examples of the present disclosure provide a system for inter-sharing of data among a plurality of data users. The system may include: a virtual dataset service subsystem; wherein the virtual dataset service subsystem is configured to in response to a data access request initiated by a data user or an application of the data user to a dataset, determine an original dataset associates to the dataset, create a virtual dataset associated with the original dataset, and return the created virtual dataset.

Examples of the present disclosure also provide a method for inter-sharing of data among a plurality of data users. The method may include: in response to a data access request initiated by a data user or an application of the data user to a dataset, determining an original dataset associates to the dataset; creating a virtual dataset associates to the determined original dataset; and returning the virtual dataset.

Examples of the present disclosure also provide a computing device, which may include: one or more processors, one or more memories, and a communication bus configured to couple the one or more processors and the one or more memories; wherein the one or more memories store one or more instructions, and when executed by the one or more processors, the instructions cause the one or more processors to perform the method for inter-sharing of data among a plurality of data users.

Examples of the present disclosure also provide a non-transitory computer-readable storage medium, which may include one or more instructions, when executed by one or more processors, cause the one or more processors to perform the method for inter-sharing of data among a plurality of data users.

Further embodiments, features, and advantages of the invention, as well as the structure and operation of the various embodiments of the invention are described in detail below with reference to accompanying drawings.

### BRIEF DESCRIPTION OF DRAWINGS

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 illustrates a conventional data asset management and data sharing System;

FIG. 2 illustrates the structure of a Collaborative System for Data Asset Management, Secured Data Sharing, and Data Processing according to examples of the present disclosure;

FIG. 3 illustrates an example of the System Components of a Data User Environment according to the present disclosure;

FIG. 4 illustrates an example of the System Components of the Data Sharing Directory Service Subsystem according to the present disclosure;

FIG. 5 illustrates an example of the System Components of the Virtual Dataset Service Subsystem according to the present disclosure;

FIG. 6A illustrates a Sample Data Object—Corporate Data Connector;

FIG. 6B illustrates a Sample Data Object—Data Server;

FIG. 6C illustrates a Sample Data Object—Registered Data File (from Home);

FIG. 6D illustrates a Sample Data Object—Registered Data File or Table (from Data Server);

FIG. 6E illustrates a Sample Data Object—Subscribed Data Item;

FIG. 6F illustrates a Sample Data Object—Registered Dataset;

FIG. 6G illustrates a Sample Data Object—Project Container;

FIG. 6H illustrates a Sample Data Object—Published Dataset;

FIG. 6I illustrates a Sample Data Object—Personalized or Role-Base Security and Privacy Access Control Rules;

FIG. 7 illustrates a process to add a Data Server according to examples of the present disclosure (related to FIG. 3);

FIG. 8A illustrates a Dataset Registration Process according to examples of the present disclosure (related to FIG. 3);

FIG. 8B illustrates a process for adding Dataset Collaborator according to examples of the present disclosure (related to FIG. 3);

FIG. 9 illustrates a Dataset Publishing Process according to examples of the present disclosure (related to FIG. 4);

FIG. 10 illustrates a Dataset Subscription Process according to examples of the present disclosure (related to FIG. 4);

FIG. 11 illustrates a Process to Initiate a Dataset Access (Connect) according to examples of the present disclosure (related to FIG. 5);

FIG. 12A illustrates a Process to Access a Subscribed Dataset or Shared Dataset according to examples of the present disclosure (related to FIG. 5);

FIG. 12B illustrates a process to Access a Directly Owned Dataset according to examples of the present disclosure (related to FIG. 5);

FIG. 13 illustrates a process of Role-based Secured Inter-Sharing of Data according to examples of the present disclosure;

FIG. 14 is an illustration of the Recursive Production of New Dataset Through the Combination of Novel and Shared data according to examples of the present disclosure;

FIG. 15 illustrates an example of the System Components in a Dataset Object;

FIG. 16 is an illustration of Dataset Data Profile Management Service according to examples of the present disclosure;

FIG. 17 illustrates a Sample Data Lineage of a dataset object (Dataset A) of a user (User-1);

FIG. 18 is an illustration of the Dataset Data Lineage Service;

FIG. 19 is an illustration of the Dataset Data Lineage Service to Build Ancestry Lineage Map;

FIG. 20 is an illustration of the Dataset Data Lineage Service to Build Descendant Lineage Map;

FIG. 21 illustrates an example of the System Components in a Project Container Object;

FIG. 22 is an illustration of the Process of Project Container Collaborator Management Service for Adding a Collaborator;

FIG. 23 is an illustration of the Project Container Manager Services.

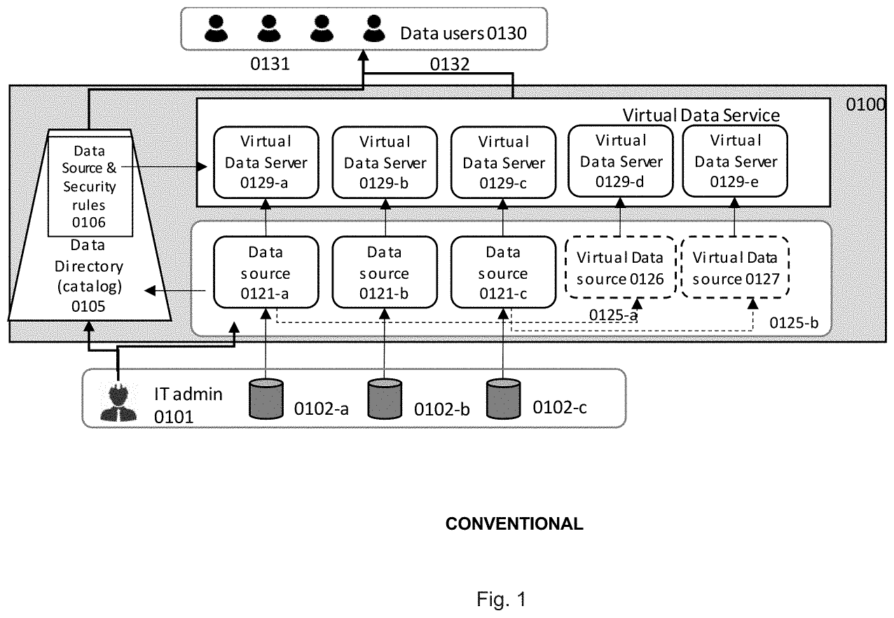

### DETAILED DESCRIPTION OF EMBODIMENTS

Embodiments of the present disclosure create a collaborative environment where a group of individuals and/or organizations can safely share their data, and work on data analytic projects together. The groups can use one another's data for processing and analytics. They can share their work results which include reports and new datasets generated from the existing data.

There are many use cases for embodiments of the present disclosure. The following are two application examples:

Connect government smart city projects where municipal government organizations can collaboratively share, exchange, and analyze data, as well as sharing information with non-government entities such as universities and companies; and

Collaborative clinical studies and research where clinicians in hospitals, scientists in research institutes, investigators in pharmaceutical companies, and managers in regulatory institutes can share their data and collaborate on data analysis.

The above-mentioned use cases are mostly new IT initiatives. Connected government project have started in many cities in China including Shenzhen, Shanghai, Guangzhou regions.

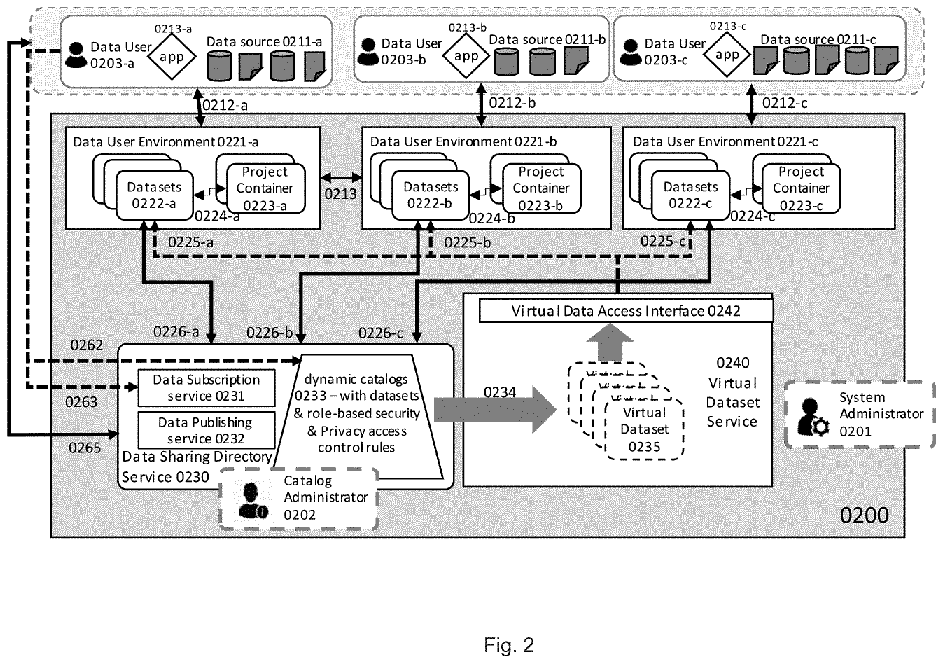

As shown in FIG. 2, according to embodiments of the present disclosure, a system 0200 that allows data users (0203-a, 0203-b, 0203-c) to self-administer the usage of their data is illustrated. Data users can use their own data, data shared by other users, and data through subscription. Data users can share their data with specific data users (collaborators) or publish their data to share with unknown data users. The embodiments of the present disclosure allow data users to share data and collaborate with one another in projects to process and analyze data.

As in FIG. 2, the embodiment of the present disclosure includes three subsystems, namely data user environment subsystem (0221), Data Sharing Directory service subsystem (0230), and Virtual Dataset Service subsystem (0240) (also referred to collectively herein as subsystems (0221, 0230, 0240), or simply subsystems). Subsystems (0221, 0230, 0240) can be implemented and deployed as one service bundle in any physical computing machine, any virtual computing machine, any software deployment container (also known as a platform-as-a-service PaaS container, such as a DOCKER container from Docket, Inc.), or in any cloud platform-as-a-service (such as Amazon Web Services AWS available from Amazon, Inc.). From here on, PaaS container and cloud PaaS are both referred to as PaaS. Alternatively, these subsystems can be configured to deploy separately in any combination of one or more physical computing machines, virtual machines, or PaaS. In one configuration, all three subsystems can be configured to run in three different machines or PaaS. In another configuration, two of the three subsystems may be deployed in one machine or a PaaS.

Additionally, subsystems (0221, 0230, 0240) may only have command line interface (CLI) and/or application programing interface (API) to interact with users and applications, or they may also have a graphical user interface (GUI). In the event when GUI is implemented, the GUI implementation is referred to as frontend, the CLI, API and the functional modules are collectively referred to as backend. In one configuration, frontend and the backend of any of the three subsystems may be implemented and deployed as one service bundle in any combination of physical machines, virtual machines, and PaaS. In another configuration, the frontend and the backend may be implemented and deployed separately, with the frontend being deployed in a WEB server or WEB cluster. In this case, the frontend communicates with the backend through the API. The backend can also be deployed in any combination of physical machines, virtual machines, and PaaS in clustering or non-clustering settings. The backend and the frontend may be configured to run in the same network or separate networks.

In clustering setting, part or all of the three subsystems (0221, 0230, 0240) can be implemented with clustering technologies where each or some of the subsystems can configure as a group of instances running in parallel computing manner. The clustering technologies may include tightly coupled clustering technology with or without shared storage, loosely coupled clustering, active-active, active-passive, and map-reduced clustering (such as Hadoop) and more. Subsystems (0221, 0230, 0240) can be implemented over any type of clustering technology. Again, these machines can be physical machines, virtual machines, or PaaS. The deployment can also be configured to have a combination of physical machines, virtual machines, and PaaS with one or more instances of any of the above subsystems running in one machine.

The deployment can reside in a data center, a private cloud, a public cloud, a hybrid cloud where a public cloud acts an extension of a private cloud or data center, and in a cloud with multiple connected clouds.

A computing machine in any of the above example implementations of subsystems (0221, 0230, 0240) may be any computing device having one or more processors and computer-readable memory. In addition to at least one processor and memory, such a computing device may include software, firmware, hardware, or a combination thereof. Software may include one or more applications and an operating system. Hardware can include, but is not limited to, a processor, memory and user interface display.

In the embodiments of the present disclosure, Data Users (0203-a, 0203-b, 0203-c) can be both data consumer and data provider; a System Administrator (0201) manages the software and hardware, manages user accounts, and assigns user role(s) to data users; a Catalog Administrator (0202) manages the Data Sharing Directory subsystem (0230), which includes a Data subscription server (0231) and one or more Dynamic Data Catalogs (0233). A Catalog Administrator (0202) creates and manages catalogs, creates and manages categories in a catalog, and defines keyword tags for categories (0233).

Unlike the conventional systems where all data are centrally owned and managed, in the embodiments of the present disclosure, data source (0211-a, 0211-b, 0211-c) belongs to the individual data user (0211-a, 0211-b, 0211-c). A data user has a Data User Environment (0221-a, 0221-b, 0221-c). Data users can only manage their own data and their projects within their own environment through a user interface (0212-a, 0212-b, 0212-c).

The embodiments of the present disclosure allow individual data users to share data with one another, and to self-administrate the usage of their data by setting personalized and role-based security and privacy access control rules.

This section describes the embodiments of the present disclosure as depicted from FIGS. 2 to 23.

FIG. 2 shows Data users (0203-a, 0203-b, 0203-c) select data items from their data sources (0211-a, 0211-b, 0211-c) and register the data items as Datasets (0222-a, 0222-b, 0222-c) into their Data Processing Environment (0221-a, 0221-b, 0221-c). For example, a data user may select a table (a data item) from a database (a Data Source 0211-a, 0211-b, 0211-c) and register it as a Dataset (0222-a, 0222-b, 0222-c). In their Data Processing Environment (0221-a, 0221-b, 0221-c), data users can create Project Containers (0223-a, 0223-b, 0223-c). Each Data User Environment (0221-a, 0221-b, 0221-c) is isolated from all others. However, data users can share datasets and collaborate (0213) with one another on their projects. In such instances, only the shared datasets and Project Containers are visible to the selected collaborators. Personalized security and privacy access control rules are defined by the data owner for the collaborator while sharing is initiated.

Data Sharing Directory service (0230) includes Dynamic Data Catalogs (0233) and Data Subscription Service (0231). Dynamic Data Catalogs (0233) contains a list of categories, and each catalog provides a Data Publishing Service (0232). The categories of a dynamic data catalog contain one or more published datasets. Each published dataset having a set of role-based security and privacy control rules defined by the data owner. Data Subscription service (0231) manages the subscription processes and subscriptions.

Data Users (0203-a, 0203-b, 0203-c) can share their data with unknown users by Publishing (0226-a, 0226-b, 0226-c) the Datasets (0222-a, 0222-b, 0222-c) in Dynamic Data Catalogs (0233). During Publishing (0226-a, 0226-b, 0226-c), data users would select a catalog and one or more categories, enter metadata for the publication, define role-based security and privacy control rules, and define a subscription approval process. Role-based security and privacy control rules specify which user/subscriber role(s) can see the published data item in the catalog, which part of the data must be masked, transformed, and filtered for which subscriber roles, as well as specific access time frame for designated subscriber roles, etc.

When a data user browses or Searches (0262) a Dynamic Data Catalog (0233) and discovers a published dataset of interest, the user can Subscribe (0263) to the data through Data Subscription Service (0231). The Data Subscription Service (0231) issues Subscription Requests (0265) to the approvers as specified in the subscription approval process that is defined by the data owner. Once the subscription is approved by all the approvers, the subscribed data item can be registered to the subscriber's dataset list (0222-a, 0222-b, 0222-c).

Data users' Datasets (0222-a, 0222-b, 0222-c) contain his/her own data, shared data (shared by collaborators), and subscribed data.

The user Project Containers (0223-a, 0223-b, 0223-c) access Datasets (0222-a, 0222-b, 0222-c) in order to clean, transform, and filter existing datasets to create new data or datasets, and to analyze the data to generate reports.

When a data user's external application (0213-a, 0213-b, 0213-c) or application in Project Containers (0223-a, 0223-b, 0223-c) accesses a Dataset (0222-a, 0222-b, 0222-c), a data access connection (0224-a, 0224-b, 0224-c) is established between the application and the dataset. If the accessed dataset is user's own dataset, the associated Dataset (0222-a, 0222-b, 0222-c) object connects (0225-a, 0225-b, 0225-c) to the Virtual Dataset Service (0240) which then creates a Virtual Dataset (0235) that connects to the actual data in user's Data Source (0211-a, 0211-b, 0211-c). If the accessed dataset is shared or subscribed data, the associated Dataset (0222-a, 0222-b, 0222-c) object connects (0225-a, 0225-b, 0225-c) to the Virtual Data Service (0240) which identifies the user's role and retrieves the associated personalized or role-based security and privacy access control rules either through the shared dataset itself or from the published dataset in the Catalog (0233). Then the Virtual Dataset Service (0240) creates a Virtual Dataset (0235) and loads the access control rules into the Virtual Data asset to perform inline data transformation and filtering purpose. The Virtual Dataset (0235) then connects to the actual data at the corresponding data source (0211-a, 0211-b, 0211-c).

In this embodiment, whenever a user's application project (note that from here on, application projects refer to external applications 0213-a, 0213-b, 0213-c and applications within Project Containers 0223-a, 0223-b, 0223-c) initiates a data access to a dataset a Virtual Dataset (0235) is created. And according to embodiments of the present disclosure, after a data access completes, the virtual dataset may be deleted to save the computing resources and storage resources of the system.

Unlike in conventional solutions where each data source has one virtual data server that enforces security rules for all users accessing the data source (one persistent virtual data server to serve many users), in the embodiments of the present disclosure, a Virtual Dataset (0235) is created spontaneously (on-demand) when a data user's application project attempts to access a shared or subscribed dataset (one virtual dataset per user data access). In the embodiments of the present disclosure, a Virtual Dataset (0235) is short-living, which is created only when an application project wants to access a shared data. The accessibility to the dataset content is limited based on the collaborator or subscriber's role; the Virtual Dataset (0235) is created to perform in-line data transformation and filtering according to the personal or role-based security and privacy rules defined by the data owner for the collaborator, or the given subscriber or subscriber group. The purpose of having a short-living virtual dataset is because the embodiments of the present disclosure is designed to support a multi-tenant environment where every user can both be a data owner and a data consumer. Each user has large number of datasets, and each user manages and administrates their data sharing. A conventional solution designed for enterprise has a single data owner (centralized management) and limited number of datasets. If the conventional solution is applied in a multi-tenant environment with multiple data owners, it would end up with a large number of persistent virtual data servers running at all time using up computing resources, and many of them may be idle most of the time.

As one can see from the above disclosure, in the embodiments of the present disclosure, data users can combine their own datasets, with subscribed datasets, and datasets shared by other data users to product new datasets and reports. New datasets can be published, which can in turn be used by other data users to create yet more new datasets, and so on. This multi-tenant collaborative model allows the creation of novel and useful information recursively.

One additional benefit of this system is that while all the original datasets may come from different data sources of different types, formats, and data access interfaces, by serving data through virtual datasets, this data sharing system presents a homogenous data access interface with a uniformed data format to all data users.

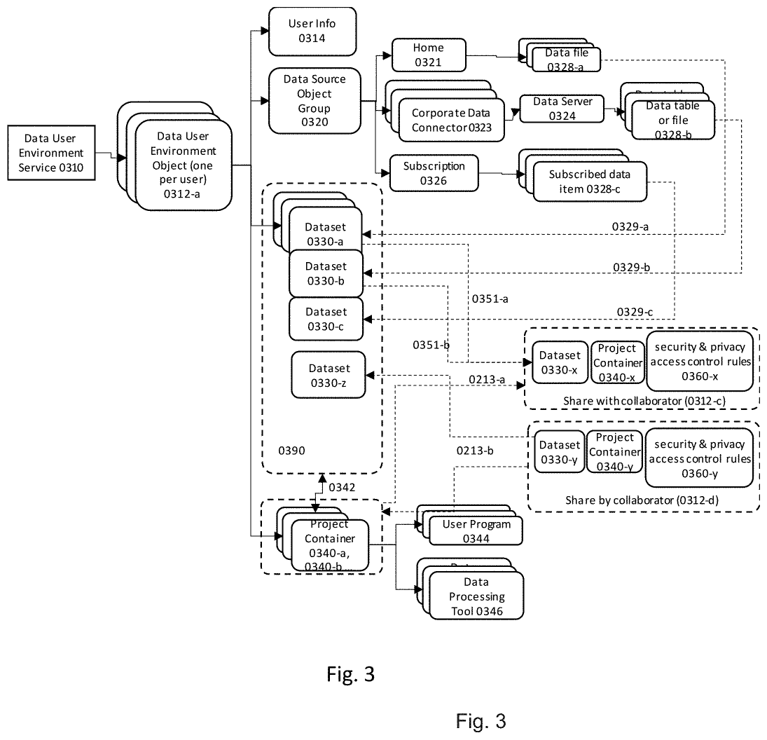

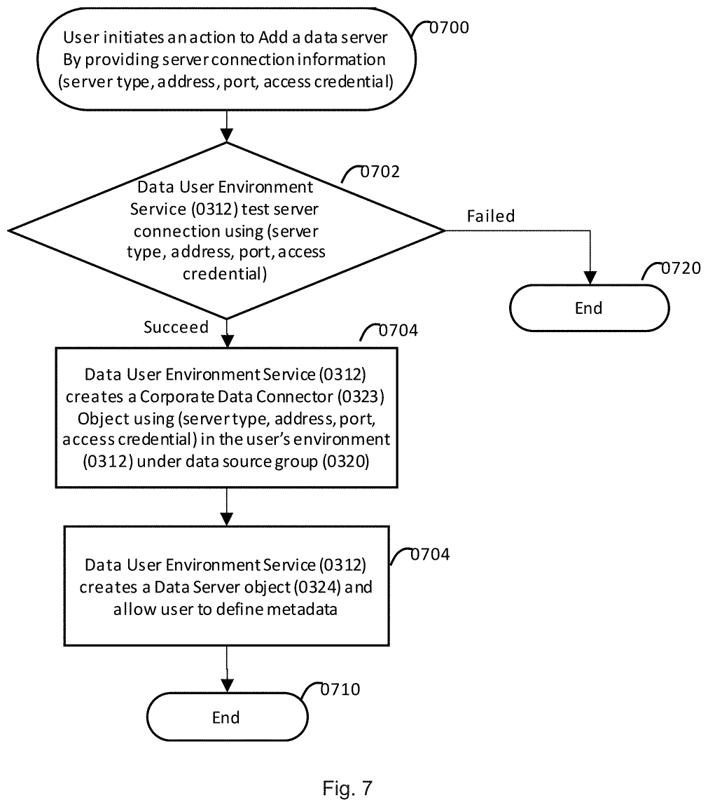

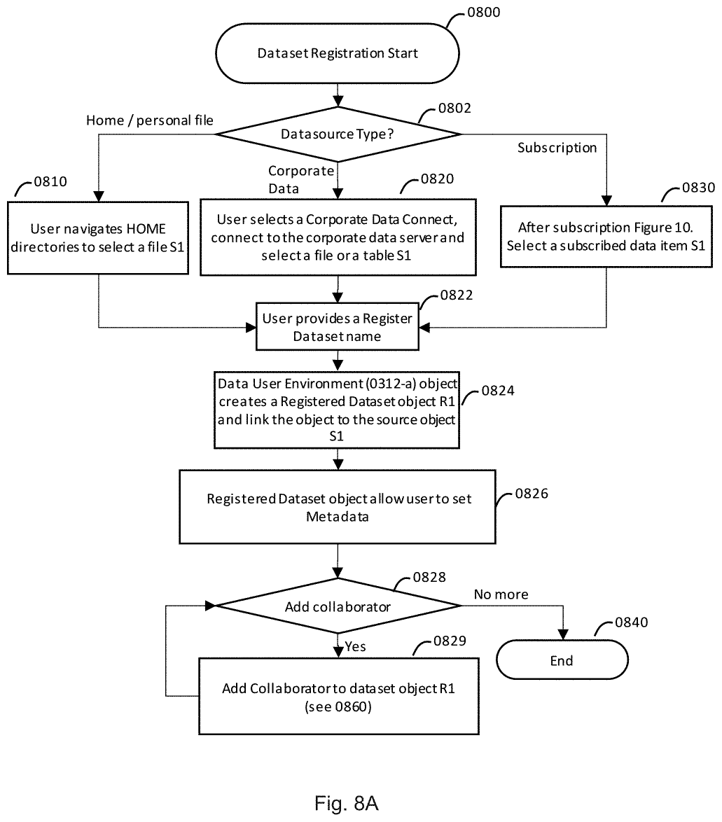

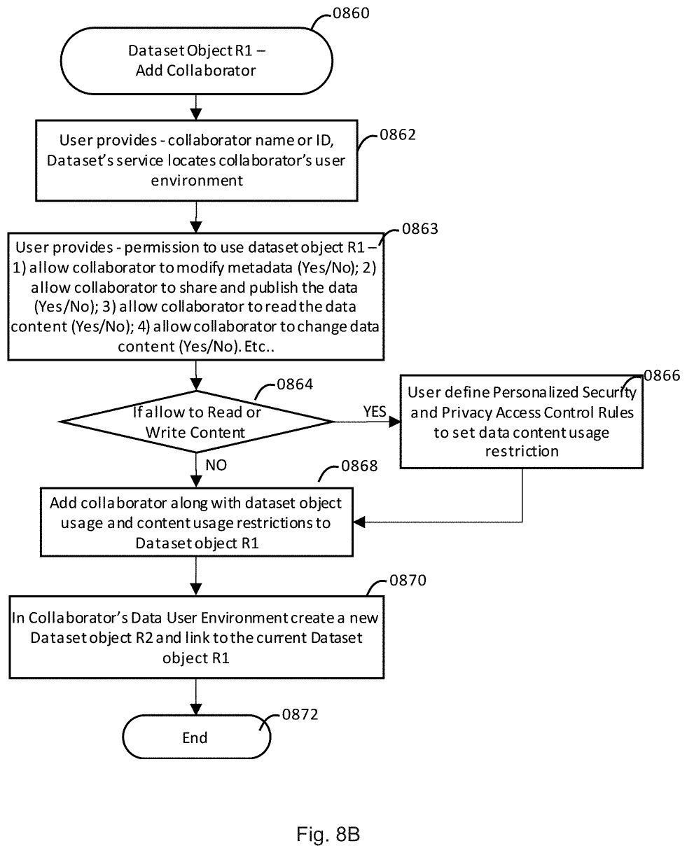

FIG. 3 shows an embodiment of the system components in a data user environment. The process of adding data servers to a data user environment and registering datasets in a data user environment are described in FIGS. 7, 8a and 8b.

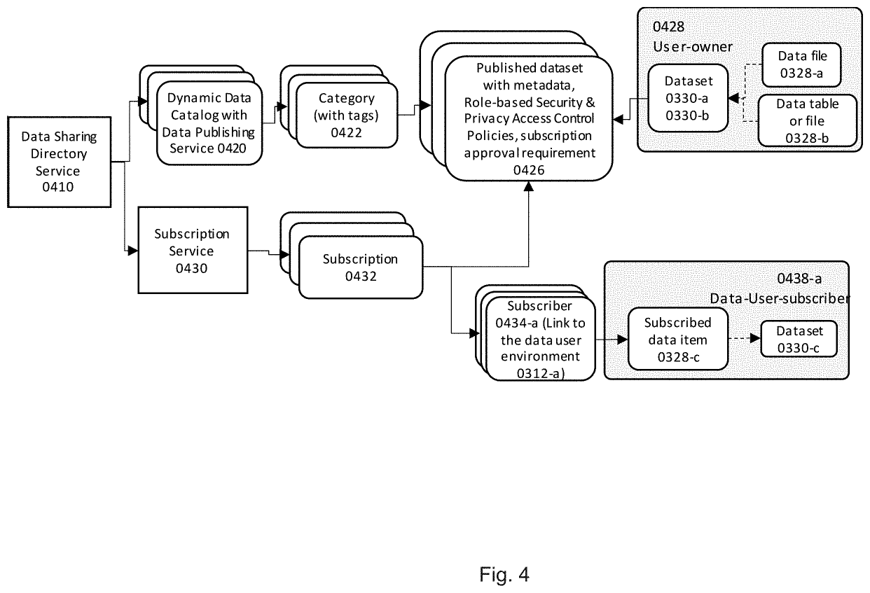

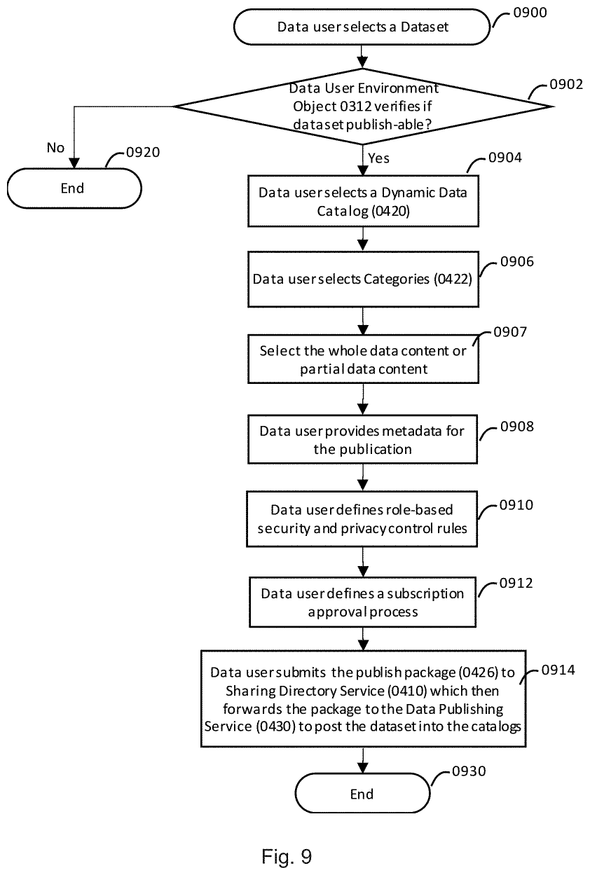

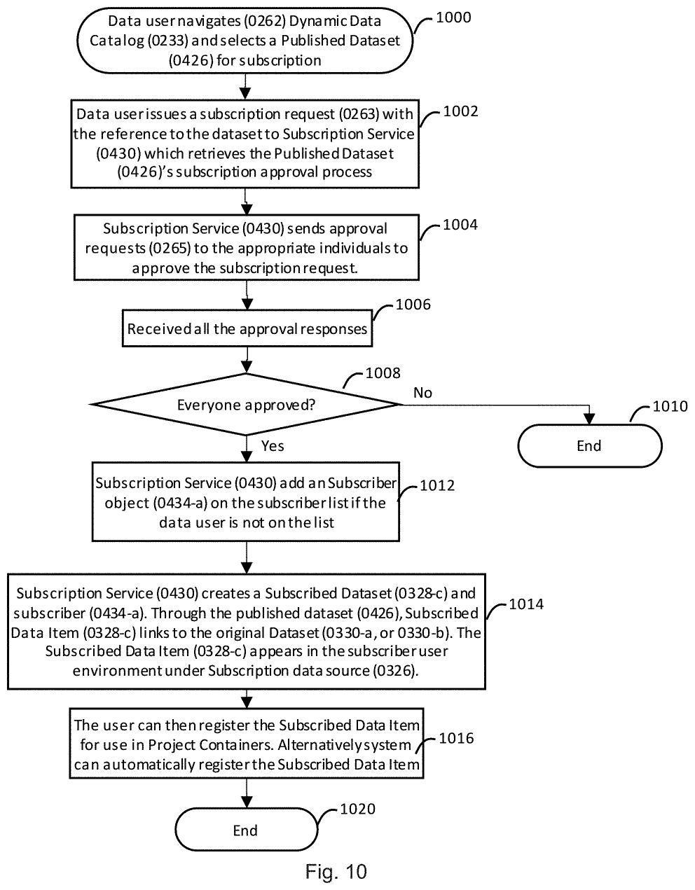

FIG. 4 shows an embodiment of the system components in the Data Sharing Directory Service subsystem. The process of publishing a dataset to this subsystem and subscribing a dataset from this subsystem are described in FIGS. 9 and 10.

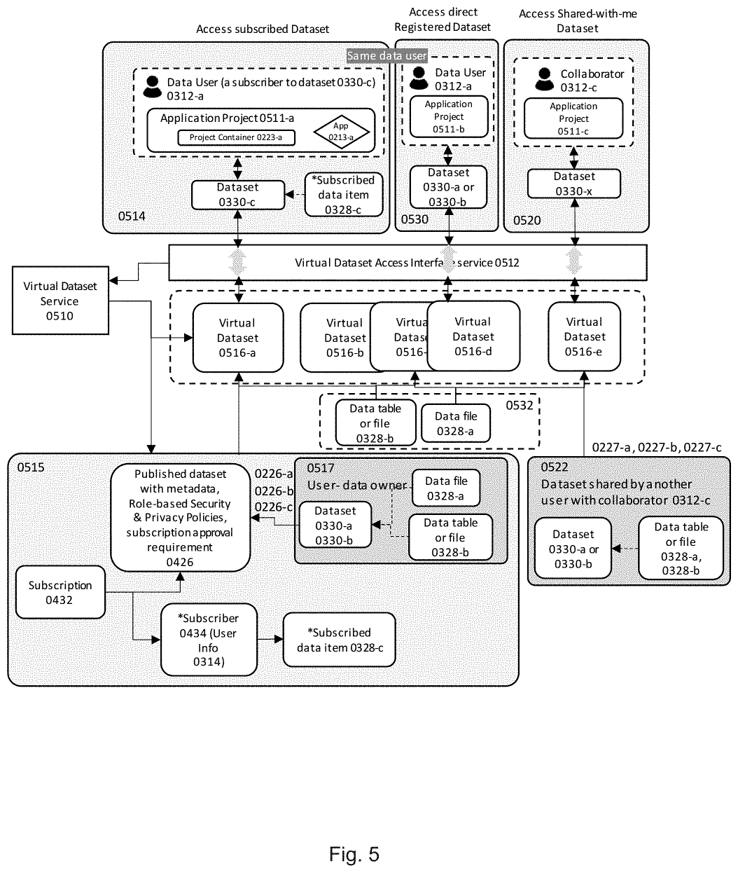

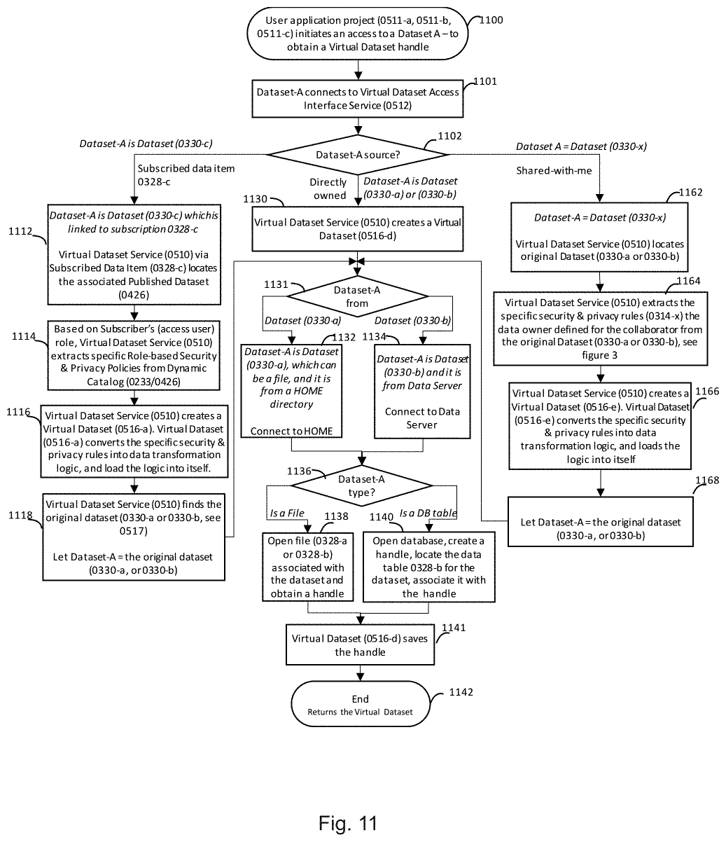

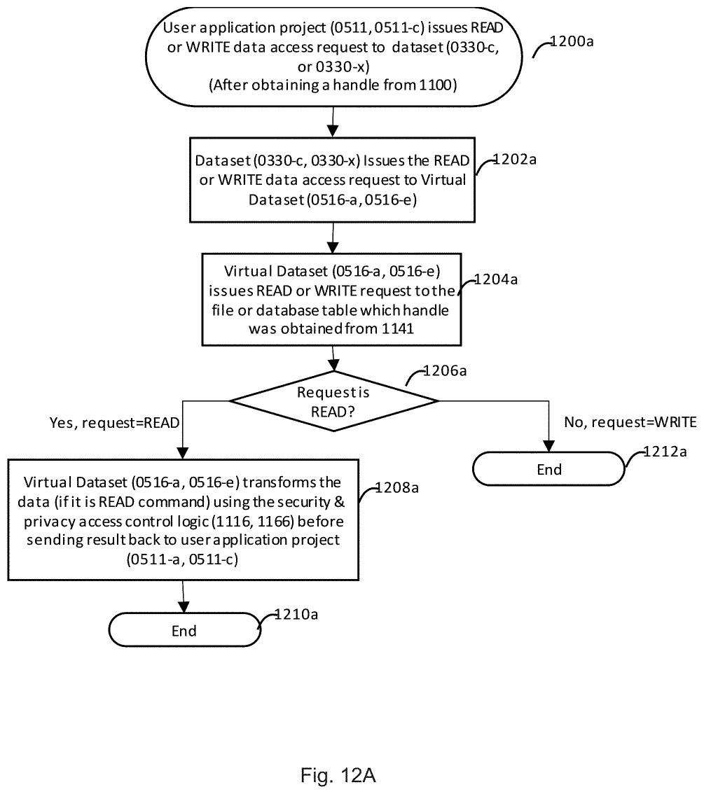

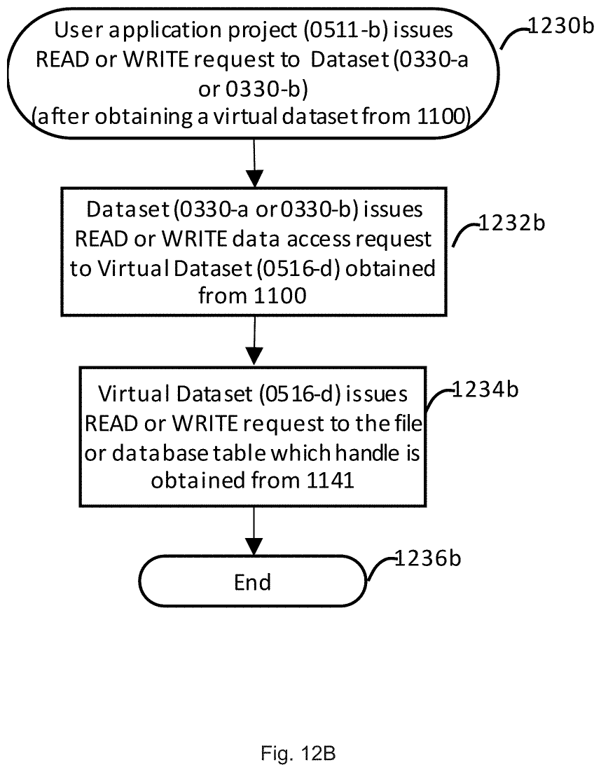

FIG. 5 shows an embodiment of the system components of the Virtual Dataset Service subsystem, which is designed to support data access. The processes of initiating an access to the datasets, as well as reading from- and writing to-datasets through Virtual Dataset Service subsystem, are described in FIGS. 11, 12a, and 12b.

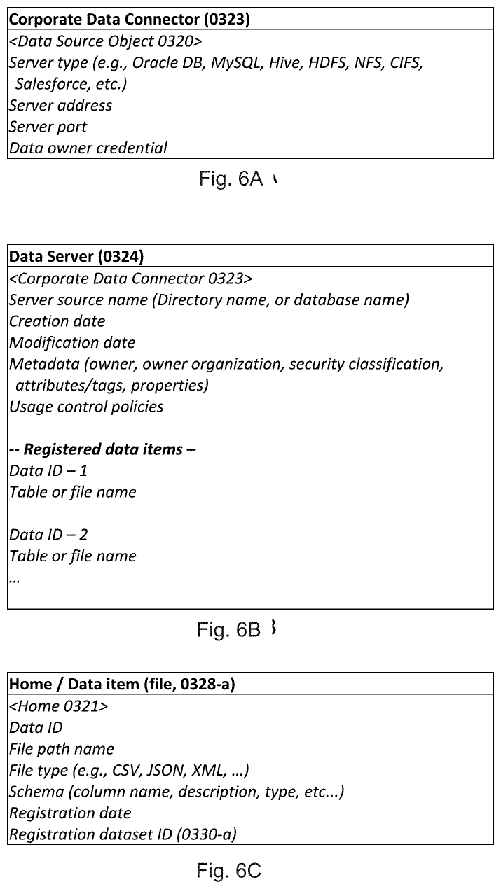

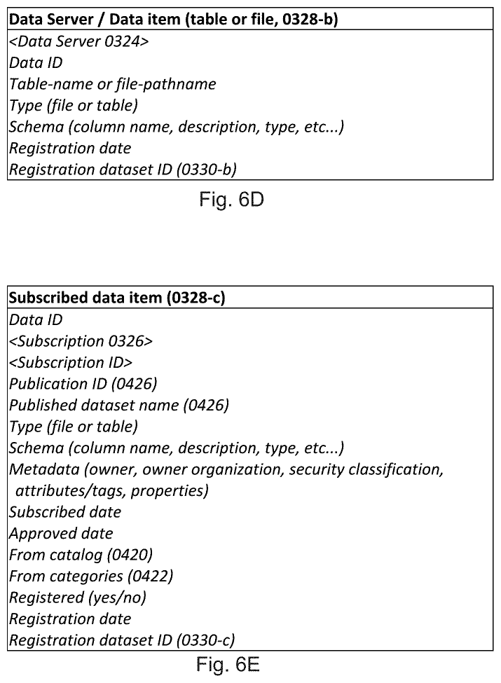

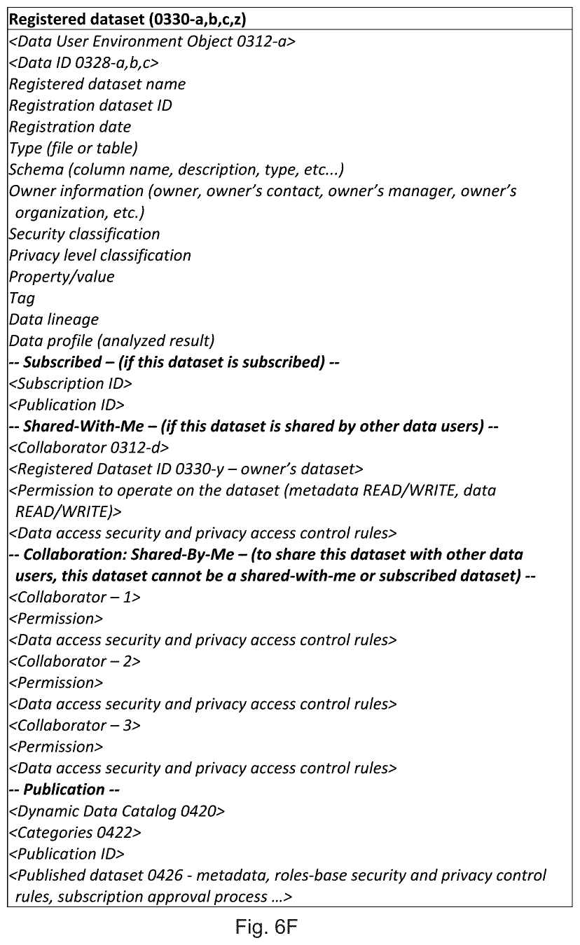

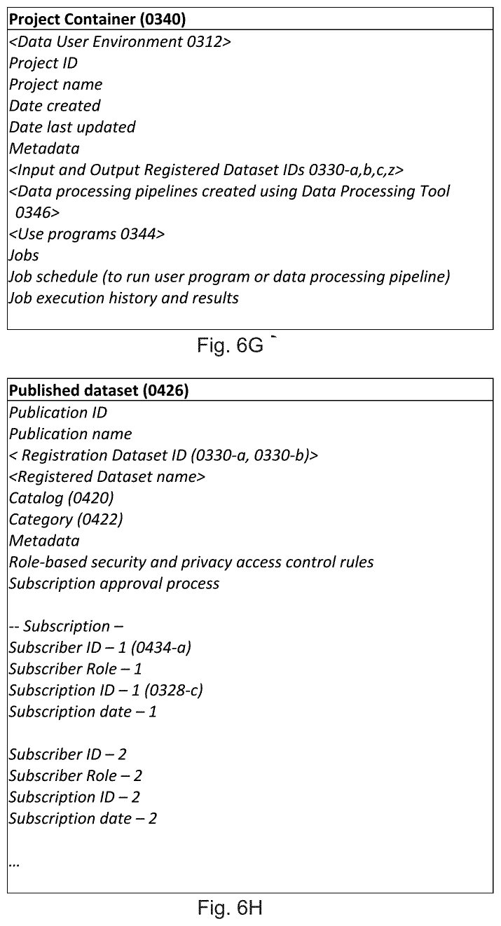

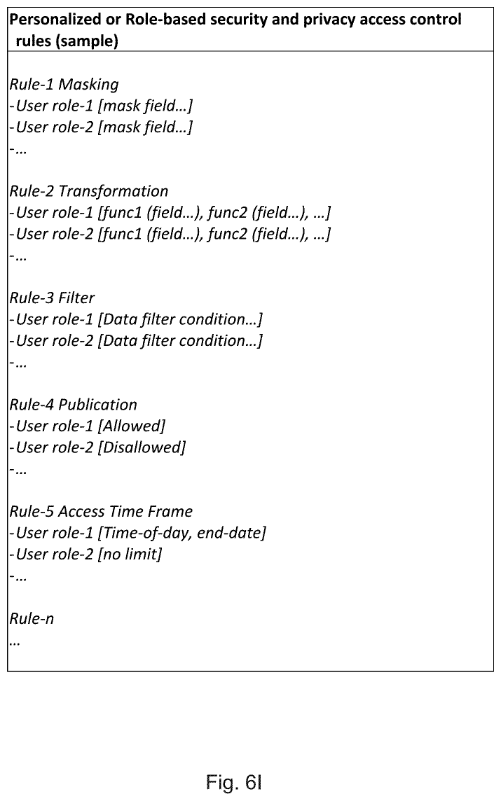

FIGS. 6A-6I show samples of several system components according to the embodiments of the present disclosure.

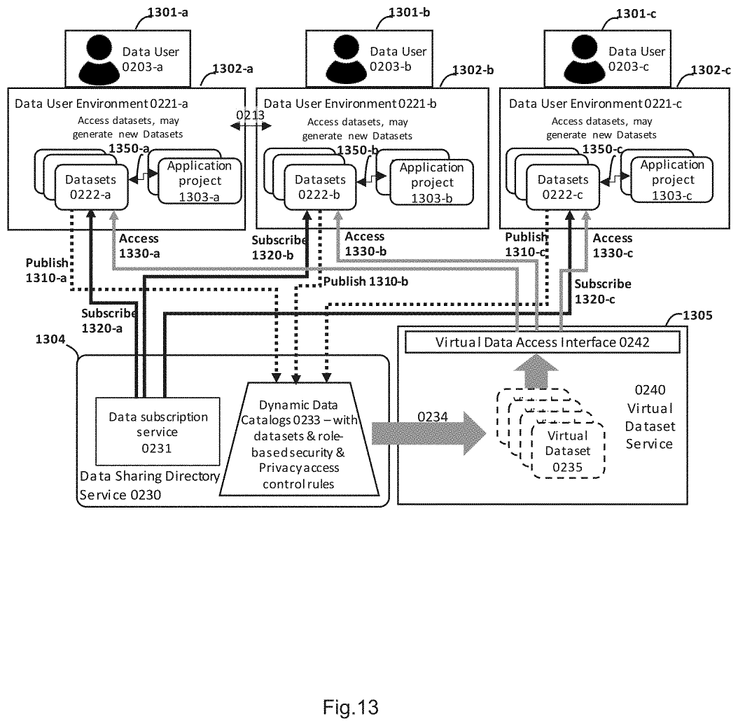

FIG. 13 shows the scenario of the embodiments of the present disclosure whereby data users securely share their data with one another through a publishing and subscription process. In the embodiments of the present disclosure, personalized and role-based secured access of shared data is enforced through virtual dataset objects which are instantiated (created) spontaneously upon data access.

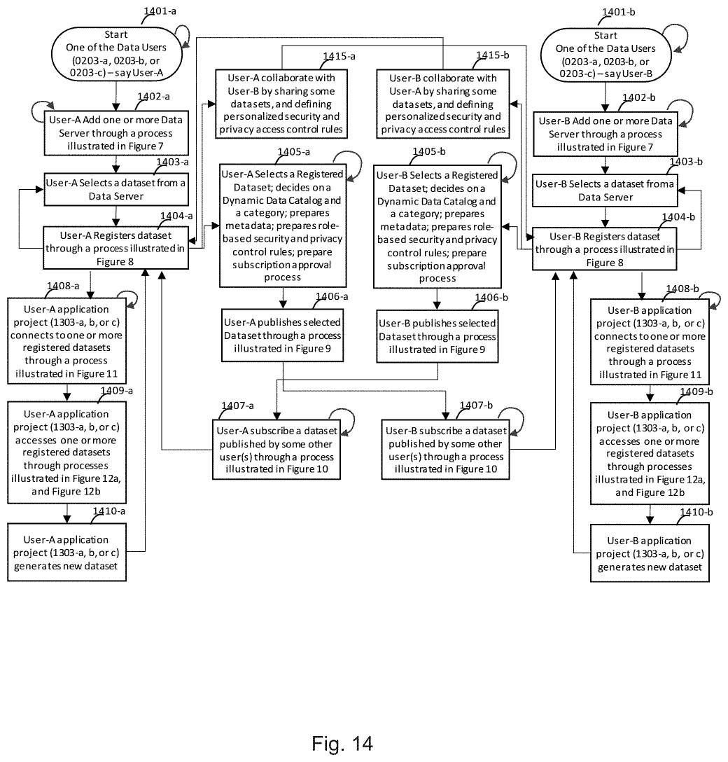

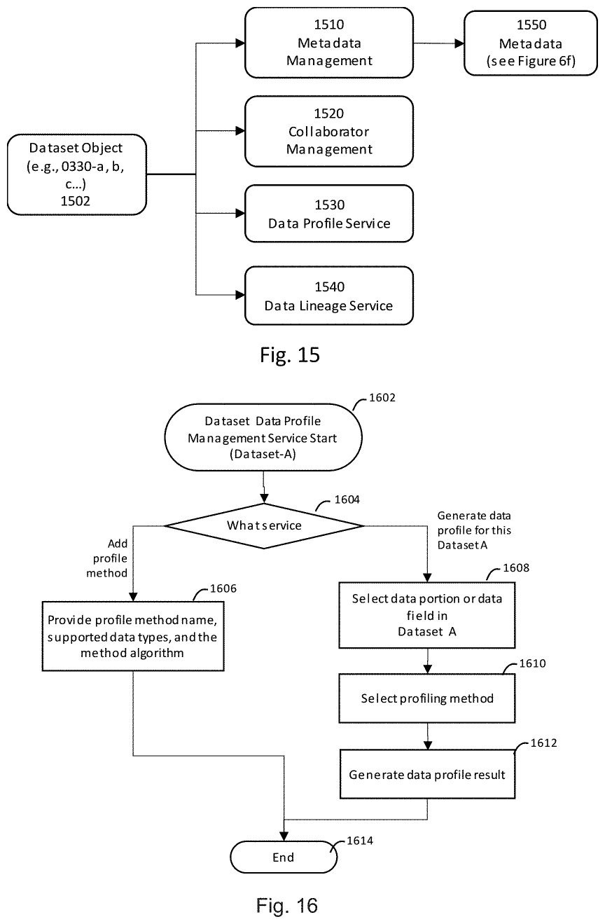

FIG. 14 illustrates a process according to embodiments of the present disclosure by which the secured inter-sharing of data among data users allows recursive production of new datasets through the combination of novel and shared data.

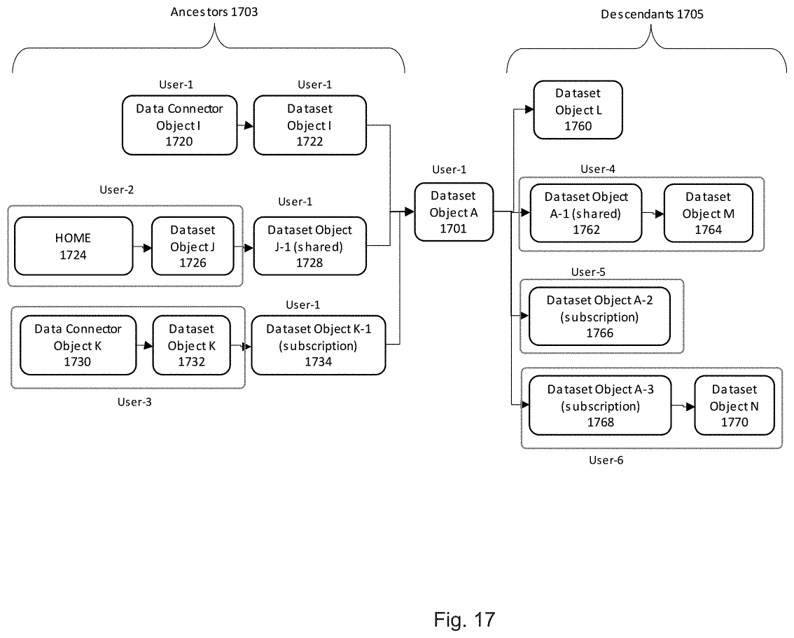

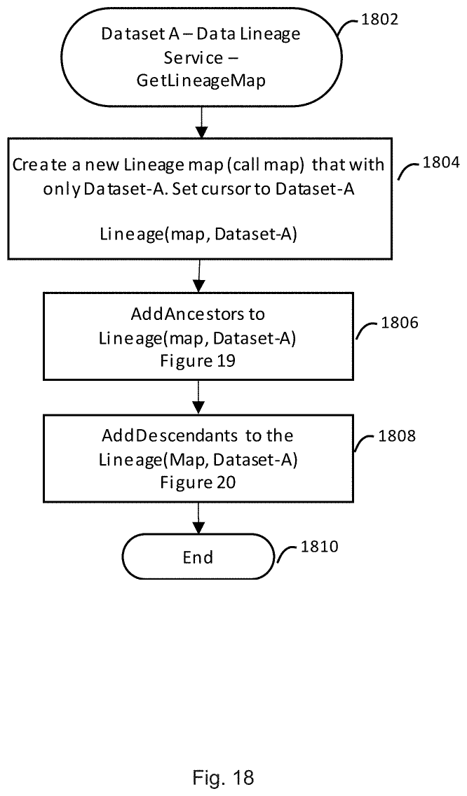

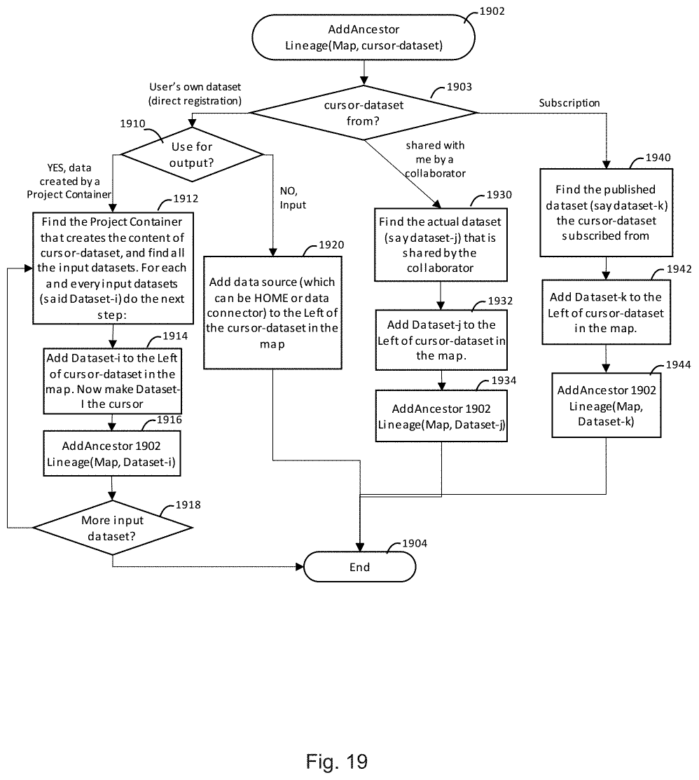

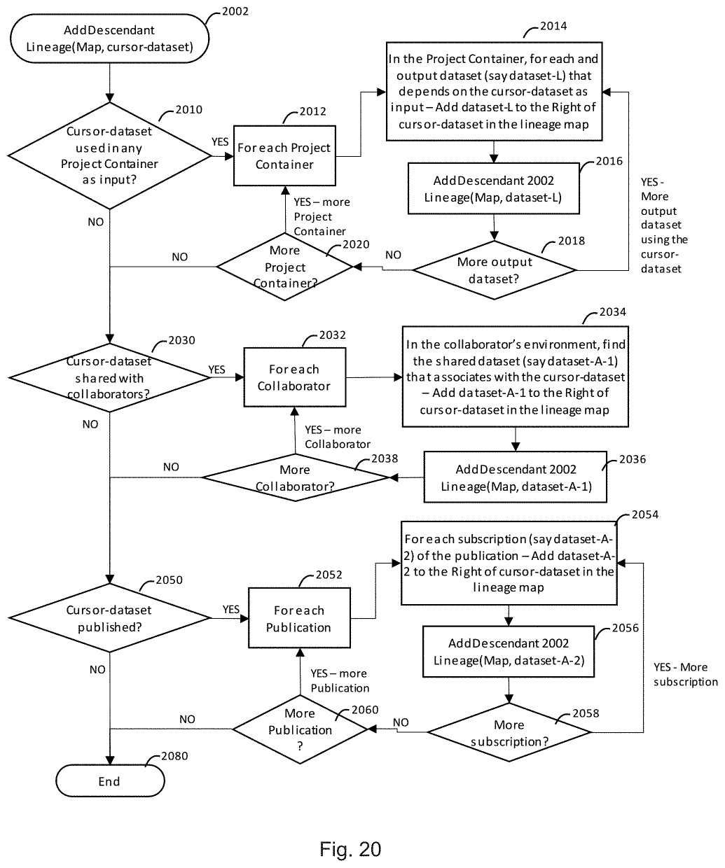

FIG. 15 shows an embodiment of the System Components in a Dataset object. FIG. 16 illustrates the Dataset data profile management service. FIG. 17 shows a sample data lineage map. FIG. 18, FIG. 19, and FIG. 20 illustrate an embodiment of the dataset data lineage service.

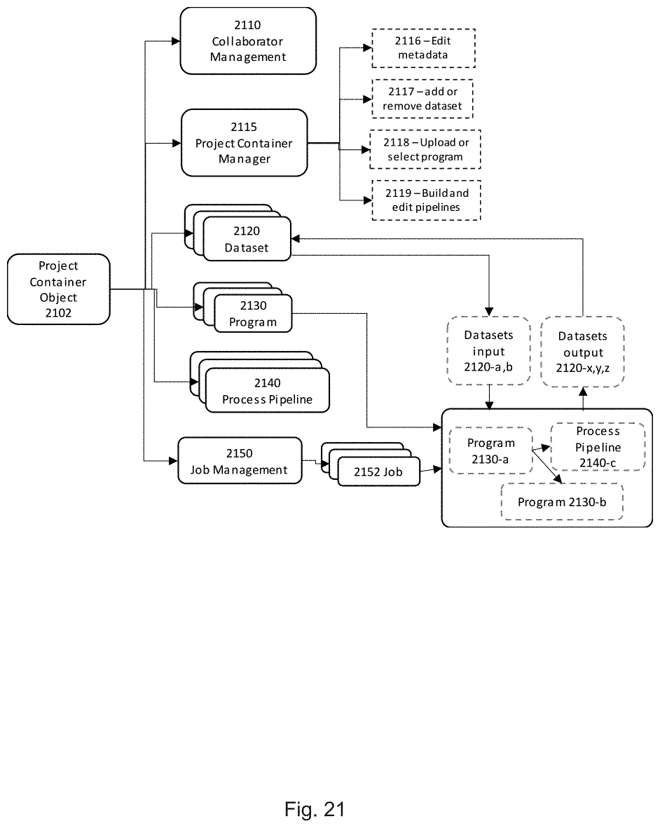

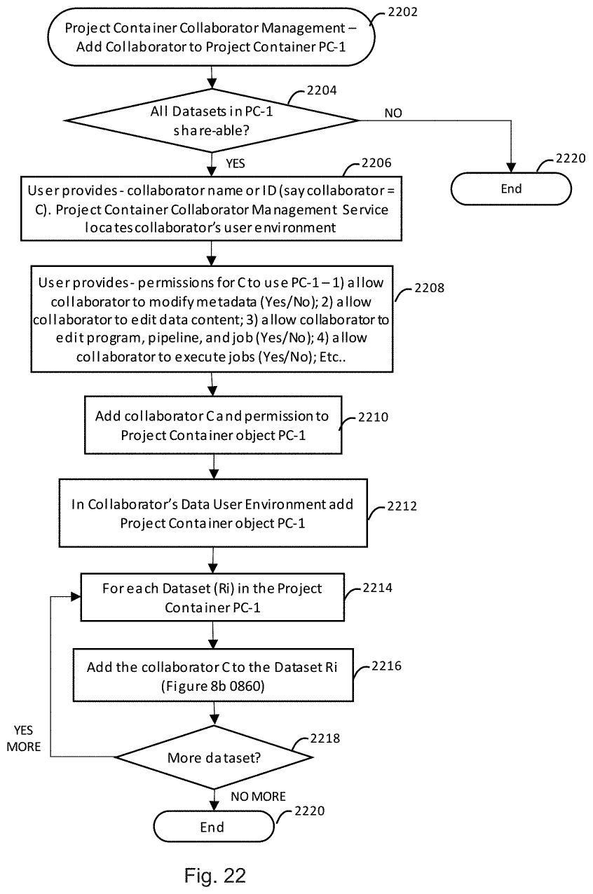

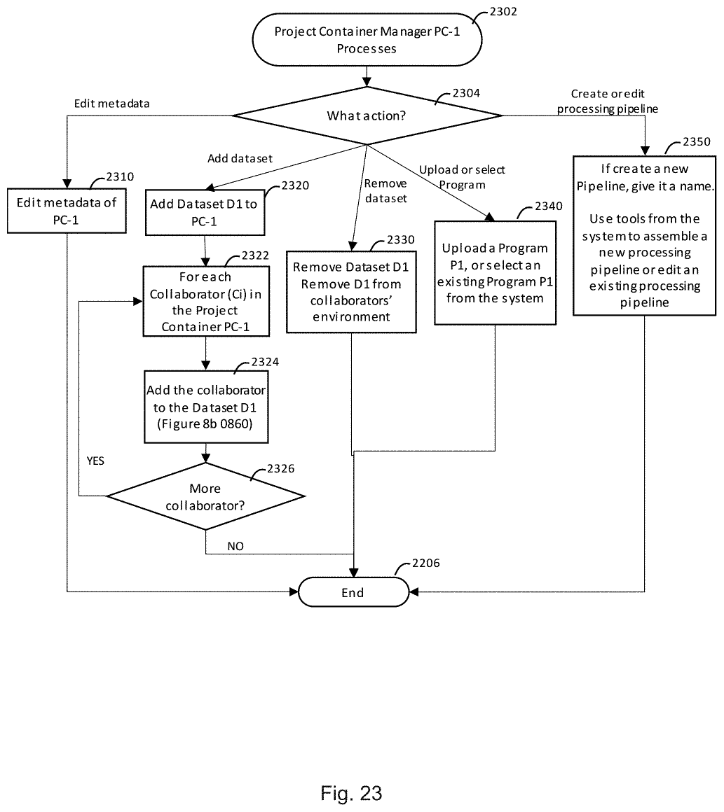

FIG. 21 shows the system components in a Project Container object. FIG. 22 illustrates the Project Container collaborator management service for adding a collaborator. Finally, FIG. 23 illustrates an embodiment of the Project Container Manager. Note that, it is possible that in alternate embodiments, the services as shown in FIGS. 16, 17, 18, 19, 20, 22 and 23 can be handled by other objects or services in the system. Current illustration simply demonstrated one of the many possible embodiments.

D.1 Data User Environment

FIG. 3 presents an embodiment of the system components of Data User Environment Service (0310, same as 0221-a, 0221-b, 0220-c) in the embodiments of the present disclosure. In this embodiment, each data user account (0203-a, 0203-b, 0203-c) is associated with a Data User Environment Object (0312-a, also 0221-a . . . c) where user information and resources allocated to the user are recorded and saved. Data User Environment Service (0310) manages all the data user environments and provides support to graphical or command line user interfaces.

In each data user environment, there are data objects such as User Information object (0314) for saving user account information, Data Source Object Group (0320) for managing the user's data sources, Datasets (0330-a . . . z), and Project Containers (0340-a . . . ). These objects are saved within the Data User Environment Object (0312-a). User Information object (0314) contains the user's account information, profile, security, and preference settings. Data source Object Group (0320) contains connectors to data sources. There are three type of data sources, namely Home (0321), Corporate Data Connectors (0323), and Subscription (0326).

Home (0321) is a connector to a personal online file store where the user can upload and store personal Data files (0328-a) that contain personal data.

Corporate Data Connectors (0323) contain connection information to corporate data servers, the information of the data servers are saved in Data Server object (0324). Corporate data servers include database servers, document servers, application data servers, etc. A data user can add corporate data servers to the system; which results in the creation of Corporate Data Connectors (0323) with information to connect to corporate data servers, and the creation of Data Server objects (0324) with metadata for managing the server. In corporate data servers, there can be Data Items such as tables or data files (0328-b) that can be used for analytics in the system. A process to add a corporate data server is shown in FIG. 7. As shown in 0700, a data user initiates an action to add a data server by providing the connection and credential information. After successfully testing the existence of the data server (0702), Data User Environment service (0312-a) creates a Corporate Data Connector object (0323) under Data Source group (0320) to store the connection information. Data User Environment service (0312-a) also creates a Data Server object (0324) to store data server metadata. FIG. 3 and FIG. 7 are simply one embodiment for managing data objects and adding data server. For example, all data server metadata may be stored in Data Connector Object (0323) rather than by creating a Data Server object (0324). In other embodiments, data resource information could be organized and managed in different ways to produce the same result.

Subscription (0326) contains a list of Subscribed Data Items (0328-c) to which the current user who owns the Data User Environment (0312-a) has subscribed. These Subscribed Data Items (0328-c) are published by other data users in Dynamic Data Catalogs (0233). An embodiment of the data publishing process is described in FIG. 9, which will be explained in a later paragraph.

Data users can create new data files or tables into their Home (0321) or Data Server (0324). The data user selects useful data items (files or tables) both for input and output and registers them as datasets for analytical and reporting purposes. When the user registers data files or tables, Dataset objects (0330-a, 0330-b, 0330-c) are created to track and manage the files and tables. FIG. 3 shows Dataset (0330-a) as a registered object of a Data File (0328-a) from Home data connector (0321), or Dataset (0330-b) as a registered object which is either a Data Item (0328-b) such as a data file or a data table from a corporate Data Server (0324), or Dataset (0330-c) as a registered object of a Subscribed Data Item (0328-c). FIG. 8a shows a process to register dataset. This process is simply an embodiment of the present disclosure. The user can register a personal data file from Home (0810), a file or a table from a Corporate Data Server (0820), or a Subscribed Dataset (0830). To register a personal data file, the data user navigates Home directory (connected by 0321) to select a personal data file, which is referred to as 51 in step 0810. To register a corporate data, the data user selects a Corporate Data Connector (0323), which connects to the corporate data server where the user can select a corporate file or a database table within the server, the file or table is referred to as 51 in step 0820. To register a subscribed dataset, the data user selects one of the Subscribed Data Items (0328-c); the selected Subscribed Data Item (0328-c) is referred to as 51 in step 0830. The data user then provides a register name for the dataset (0822). The Data User Environment (0312-a) then creates a registered Dataset object R1 (0330-a, 0330-b, or 0330-c) and links the Dataset object R1 to the selected data item Si (0824). The data user can then enter metadata 0826 to the registered Dataset R1 (0330-a, 0330-b, or 0330-c), then continue to add one or more collaborators (e.g., 0312-c) to the dataset object R1 in steps 0828 and 0829 (see FIG. 8B). An embodiment of the process to add dataset collaborator is in FIG. 8B. In step 0862, the data user provides a collaborator's information which can include the collaborator's name and ID. The dataset R1 then locates the collaborator's user environment. In step 0863, the data user can set permissions for the collaborator to restrict what the collaborator can do to the dataset object. For example, is the collaborator allowed to make changes to metadata in the dataset object; can the collaborator share and publish information and data of the dataset object; can the collaborator read or write the data contents of the data item associates with the dataset object. If the collaborator is allowed to read or write data contents, then in step 0866 data user defines personalized security and privacy access control rules (e.g., 0360-x) to restrict the collaborator's access to the data content. This may be used for example to filter sensitive data. Sensitive data as used herein refers to data that may need to have access restricted for security and/or privacy control reasons. For example, the rules may specify which part of the content has to be masked, which part of the content has to be filtered out, and which part of the content needs to be transformed before sharing with the collaborator. In step 0868, the collaborator, the dataset object usage permissions, and the personalized security and privacy data content access control rules are written into the source dataset object (in this example it is R1). Then in step 0870, a new dataset object R2 is created in the collaborator's Data User Environment (e.g., 0312-a). The new data object R2 (e.g., 0330-x) is linked to its source dataset object R1 (e.g., 0330-a, 0330-b, or 0330-c).

Collaborators can be added and removed at any time after a dataset is registered and dataset object is created.

Note that Adding collaborator(s) is different from data sharing through publishing. Publishing dataset is to share datasets with unknown subscribers, whereas adding collaborators to a dataset is to share data directly with known data users.

As depicted in FIG. 3, the current data user (Environment 0312-a) shares (see 0351-a and 0351-b) his/her Dataset (0330-a or 0330-b) with a Collaborator (0312-c). The shared Dataset (0330-a or 0330-b) appears in the Collaborator's (0312-c) environment as Dataset (0330-x). The current data user (Environment 0312-a) defines personalized Security and Privacy Access Control Rules (0360-x) for the Collaborator (0312-c). As shown also in FIG. 3, another data user/Collaborator (0312-d) shares his/her Dataset (0330-y) with the current data user (Environment 0312-a). The shared Dataset (0330-y) appears as Dataset (0330-z) in the current data user's Environment (0312-a). Collaborator (0312-d) also defines personalized

Security and Privacy Access Control Rules (0360-y) for the current user (user of 0312-a). This means that when the current user (user of 0312-a) accesses Dataset (0330-z), he/she may not see the full content in Dataset (0330-y). The data received by Dataset (0330-z) is transformed according to the personalized Security and Privacy Control Rules (0360-y) defined by the collaborator (0312-d).

The purpose of registering data items as datasets in the embodiments of the present disclosure is simply a way to track and management selected data items, and to administrate and control their usage. In an alternate embodiment, all data items from users' personal storage and corporate servers are tracked and managed such that there is no need to register data items.

A dataset object can have metadata (see FIG. 6) and service method. FIG. 15 shows an illustration of a dataset object.

A data user can create Project Containers (0340-a, 0340-b, . . . ) in his/her Environment (0312-a). Project resources are managed in the Project Container objects (0340-a, 0340-b, . . . ). Within a Project Container, a data user selects (0342) one or more Datasets (from 0330-a, 0330-b, 0330-c, 0330-z), creates User Program (0344), and/or uses Data Processing Tools (0346) associated with the system to process and analyze the data, and generates reports or produces new data into the datasets (through 0342). Some datasets are used for data input, some are for data output (to create new dataset), some datasets are used for both input and output. User Programs (0344) and Data Processing Tools (0346) within Project Containers can create new datasets into the registered Dataset Pool (0390). A Project Container object is illustrated in FIG. 21.

FIG. 3 also shows that Dataset (0330-x) shared with data user/Collaborator (0312-c) is used in the collaborator's Project Container (0340-x). The Dataset (0330-z) that is shared by Collaborator (0312-d) is used in the collaborator's Project Container (0340-y), and Project Container (0340-y) is also shared by Collaborator (0312-d) with the current user whose Environment is 0312-a.

### D.1.1 Dataset Services

FIG. 15 shows the current embodiment of the system components in a dataset object. A Dataset object (1502) consists of Metadata Management service (1510), Collaborator Management service (1520), Data Profile Service (1530), and Data Lineage Service (1540). Dataset object (1502) is also shown in the example in FIG. 3 as 0330-a, 0330-b, 0330-c, etc.

Metadata Management service (1510) manages dataset metadata (1550) captures in the Dataset object. Dataset metadata includes:

| - | Link to Data User Environment (e.g., 0312-a) | |
|---|---|---|
| - | Link to the dataset's data item by way of a data ID | |
| | (data item from HOME, from a data | |
| | connector, a subscription, or a shared item, e.g., | |
| | 0328-a, 0328-b, etc. . .) | |
| - | This Dataset ID and name | |
| - | Data type and schema | |
| - | Owner's information (owner, owner's manager, | |
| | and owner's organization) | |
| - | Security classification of the data content | |
| - | Privacy classification of the data content | |
| - | Data lineage | |
| - | Data profiles | |
| - | <If subscription> | |
| | [symbol] | Subscription info-subscriptionID and the associated publication |
| - | <If shared-with-me> | |
| | [symbol] | Collaborator info, permission, and personalized security and |
| | | access control rules defined for me |
| - | <If shared-by-me> | |
| | [symbol] | List of collaborators, for each collaborator: |

| | |
|---|---|
| ú | Collaborator info, permission, and |
| | personalized security and access control |
| | rules defined for the collaborator |

| - | <if published> | |
|---|---|---|
| | [symbol] | List of publications, for each publication: |

| | |
|---|---|
| ú | The catalog and category |
| ú | Publication ID, name, metadata, |
| ú | Role-based security and access control rules |
| ú | Subscription approval process |
| ú | List of subscribers |

The Dataset metadata is also shown in FIG. 6F (Sample Data Object—Registered Dataset). Metadata Management service (1510) manages and stores the metadata of the Dataset object in a storage that can be of any type of media and formatted in any type structure, such as but not limited to memory, rotating fixed disk, solid state drives (SSDs), RAID, NAS, SAN, database, object stores, etc. Through the metadata, a dataset object (1502) is connected to its user environment (e.g., 0312-a), original data item (e.g., 0328-a, 0328-b, 0328-c, . . . ), subscription (if the data is a subscription), collaborators, and its publication in catalogs. Metadata also include description of its data contents such as data format, schema, properties, tags, security and privacy classification. In addition, Dataset Data Profile Service (1530) generates data profiles information, and Data Lineage Service (1540) generates data lineage map, this information is also managed by Metadata Management service (1510) in the current embodiment.

Collaborator Management service (1520) manages collaborators. It allows a data user to share the current dataset with other users (collaborators). This Collaborator Management service (1520) allows the data owner to add collaborator, remove collaborator, change sharing permission, and change personalized security and privacy data content access control rules. FIG. 8B illustrates the process of adding a collaborator by this Collaborator Management service (1520). Note that FIG. 8B is simply an embodiment of the present disclosure. In a different embodiment, collaborator management can be done outside of a dataset. For example, it can be part of the services in the Data User Environment (example: 0312-a). Once a collaborator is added, the collaborator's information is sent to the Metadata Management service (1510) to store in the Dataset object.

Data Profile Service (1530) is illustrated in FIG. 16 (1602). Data Profile Service (1530) allows data user to add data profile methods (1604, 1606) and to inspect data content (1604, 1608). For example, user can inspect if a data field has unique value and that if the field can be used as a key; user can inspect the data value distribution of a field; the average value; and so on. While the embodiments of the present disclosure can include built-in data profile methods, as shown in steps 1604 and 1606, Data Profile Service (1530) allows data users to add custom data profile methods. A data profile method has a given a name, data types the method can inspect, and the algorithm for inspecting a data field. For example, a method with an algorithm to inspect a timestamp of a specific dataset can only handle date and time data types. To perform data inspection, in step 1608, Data Profile Service (1530) lets data user selects a data portion or a data field in the dataset to inspect. Then in step 1610, user selects one of the profile methods (from system provided methods and custom methods added by users). In step 1612, Data Profile Service (1530) executes the method against the selected data, the generated data profile result is given to the Metadata Management Service (1510) to store in the Dataset object. The execution of a data profiling process in step 1612 can be triggered by a data user or can be automatically generated by the Data Profile Service (1530). The Data Profile Service (1530) of a Dataset object can also automatically performs data inspection by automatically binding specific a profile method to a specific data type and automatically generates data profile results. Note that FIG. 16 is simply an embodiment of the present disclosure. In a different embodiment, a Data Profile Service can be done outside of a dataset. For example, it can be part of the services in the Data User Environment (example: 0312-a).

An Embodiment of Data Lineage Service (1540) is illustrated in FIG. 18 (1802), FIG. 19, and FIG. 20. Data Lineage Service (1540) generates data lineage map for a dataset. A generated data lineage map can be stored in a dataset object and can be managed by Metadata Management service (1510). FIG. 17 shows a sample data lineage map of a dataset.

FIG. 17 is a sample data lineage map of a dataset object (say Dataset-A, 1701) which is owned by user (say User-1). In this map, to the left side of the map are the ancestors (1703) of Dataset-A, to the right of the map are the descendants of Dataset-A. The data contents of the ancestor objects (1703) are the source of the data content of Dataset-A (i.e., the data item of Dataset-A); this means that the data content of Dataset-A is the derivative product of the data contents of its ancestors. In the contrary, the data contents of the descendant datasets are the derivative products of the data content of Dataset-A. The content of a descendant (say Dataset M) may be a product of the data from Dataset-A and some other datasets, but for the current embodiment, in the data lineage map of Dataset-A, these other datasets are not shown.

FIG. 18 begins with the Data Lineage Service (1540) receiving the reference to a dataset (say Dataset-A). A dataset reference may be an identifier, a name, or an address of the dataset. In step 1804, a new lineage map is created (refer to as Map) with only one node (Dataset-A). Using FIG. 7 as an example, this step generates a map with only Dataset-A (1701) without Ancestor and without Descendant. Step 1804, also sets the cursor of the map at Dataset-A. The entire lineage map with a cursor location set at Dataset-A is referred to as Lineage (Map, Dataset-A). In step 1806, the entire ancestry portion of the map is added to the left side of Dataset-A in the lineage map. Step 1806 is illustrated in FIG. 19. In step 1808, the entire descendant portion of the map is added to the right side of Dataset-A in the lineage map. Step 1808 is illustrated in FIG. 20.

FIG. 19 illustrates an embodiment of the process to add ancestry lineage map of the cursor dataset. FIG. 18 step 1806 calls for the addition of ancestry map of Dataset-A 1701—Lineage (Map, Dataset-A). This section uses example in FIG. 17 to illustrate how the ancestor datasets are added to the map. Step 1903 checks where the cursor-dataset comes from. In the embodiments of the present disclosure, a dataset can come from a (i) direct registration (e.g., dataset 0330-a or 0330-b, see FIG. 3) of the data owner's data item (0328-a or 0328-b) from the data owner's Home (0321) or a data server (0324 via a data connector 0323); (ii) shared by a collaborator (0330-z, shared by collaborator 0312-d); or (iii) subscription (0330-c from subscribed data item 0328-c). In the event if the cursor-dataset is a direct registration dataset, in step 1910, Data Lineage Service (1540) checks if the dataset contains generated data (i.e., the dataset is an output dataset). If cursor-dataset is as an output, in step 1912, the Data Lineage Service (1540) locates the Project Container where the content of the cursor-dataset is generated by some input datasets. The Data Lineage Service (1540) finds all the input datasets that contribute data to the content of the cursor-dataset. Using FIG. 17 as example, at this point, the cursor-dataset is Dataset-A 1701. Data Lineage Service (1540) found that Dataset-A (1701) is an integration of Dataset-I (1722), Dataset-J-1 (1728), and Dataset-K-1 (1734). The Data Lineage Service (1540) iterates through the steps 1912, 1914, 1916, and 1918 to add Dataset-I (1722), Dataset-J-1 (1728), Dataset-K-1 (1734) and their ancestors to the left side of Dataset-A as they appear in FIG. 17.

Taking Dataset-I (1722) as an example, in step 1914, Dataset-I (1722) is first added to the left side of Dataset-A (1701 the cursor-dataset), then the cursor is set to Dataset-I (1722). Step 1916 begins building ancestor for Dataset-I (1722, now the cursor), the process loops back to 1902. It appears that Dataset-I (1722) is also a direct registration, so the process goes from 1902, to 1903, and then 1910. In this case, the cursor-dataset, Dataset-I (1722), is not an output, so the process goes to 1920, where the Data Connector (1720) in the current user's environment (User-1) is added to the left of Dataset-I (1722) as shown in FIG. 17.

Now, back to step 1914, when Dataset-J-1 (1728) is added to the left side of Dataset-A (1701), and the cursor-dataset is set to Dataset-J-1 (1728). Step 1916 begins building ancestor for Dataset-J-1 (1728, now the cursor), the process loops back to 1902. In step 1903, Data Lineage Service (1540) found that Dataset-J-1 (1728) is a shared dataset, so the process moves to 1930 where the actual dataset-J (1726) from User-2's environment is found. In step 1932, Dataset-J (1726) is added to the left of Dataset-J-1 (1728). Now the cursor is set to Dataset-J (1726), step 1934 begins building ancestor for Dataset-J (1726, now the cursor), and the process loops back to 1902. It appears that Dataset-I (1726) is a direct registration in User-2's environment, the process goes from 1902, to 1903, and then 1910. The cursor-dataset, Dataset-J (1726), is not an output, so the process goes to 1920, where HOME of User-2 1724 is added to the left of Dataset 1726 as shown in FIG. 17.

Again, back to step 1914, when Dataset-K-1 (1734) is added to the left side of Dataset-A (1701), and the cursor-dataset is set to Dataset-K-1 (1734). Step 1916 begins building ancestor for Dataset-K-1 (1734, now the cursor), the process loops back to 1902. In step 1903, Data Lineage Service (1540) found that Dataset-K-1 (1734) is a subscription, so the process moves to 1940 where the actual dataset-K (1732) in User-3's environment is found. Note that this is because User-3 published Dataset-K (1732), and User-1 subscribed the publication. The subscription appears as Dataset-K-1 (1734) in User-1's environment. In step 1942 Dataset-K (1732) is added to the left of Dataset-K-1 (1734). Now the cursor is set to Dataset-K (1732), step 1944 begins building ancestor for Dataset-K (1732, now the cursor), and the process loops back to 1902. It appears that Dataset-K (1732) is a direct registration in User-3's environment, the process goes from 1902, to 1903, and then 1910. The cursor-dataset, Dataset-K (1732), is not an output, so the process goes to 1920, where the Data Connector-K (1730) in User-3's environment is added to the left of Dataset-K (1732) as shown in FIG. 17.

After the entire Ancestor maps is created for Dataset-A (1701) in FIG. 18 step 1806, the next step 1808 is to build the Descendant map. Using FIG. 17 as an example, Dataset-A (1701) is set as the cursor-dataset. Step 1808 is illustrated in FIG. 20. In FIG. 20, step 2010, Data Lineage Service (1540) checks if the cursor-dataset (Dataset-A, 1701) is used in any Project Container as an input to create any new output dataset. Note and all the new output datasets are descendants of Dataset-A (1701). If step 2010 check out as yes, steps 2012, 2014, 2016, 2018, and 2020 iterates through all the Project Containers and add all the new output datasets to the right of Dataset-A (1701). After checking for Dataset-A's output, step 2030 checks if Dataset-A (1701) is shared with any collaborator. If so, in steps 2032, 2034, 2036, and 2038 the corresponding datasets in the collaborator's environments are added into the map as descendants. Further, the descendants of the shared datasets at the collaborators are also added to the map (see step 2036). In step 2050, Data Lineage Service (1540) checks if Dataset-A (1701) is published. If YES, steps 2052, 2054, 2056, 2058, and 2060, iterates through all the publications and the associated subscriptions, adding the subscription Datasets as descendants in step 2054. Further, in step 2056, Data Lineage Service (1540) adds the descendants of the subscriptions to the lineage map. Following paragraphs provide more detailed descriptions using FIG. 17 as an example.

In step 2010, where Data Lineage Service (1540) checks if the cursor-dataset, Dataset-A (1701), has dependent output datasets (derivative datasets). If so, in step 2012, for each Project Container (steps 2012, 2020), and for each output (derivative) dataset(s) (step 2014, 2018) that depends on the cursor-dataset (Dataset-A 1701 at the moment), in step 2014, Data Lineage Service (1540) adds those output datasets to the right of the cursor-dataset. Based on FIG. 17, Dataset-L (1760) is the only derivative dataset, so it is added to the right of Dataset-A (1701). Step 2016 check to see if Dataset-L (1760) has descendent by looping back to 2002 to add the descendant of Dataset-L (1760). In this case, Dataset-L (1760) does not have descendant.

In step 2030, where Data Lineage Service (1540) checks if the cursor-dataset (Dataset-A, 1701) has been shared with collaborators. If YES, steps 2032 and 2038 go through each and every collaborator(s). In Step 2034, Data Lineage Service (1540) finds the corresponding dataset in the collaborator's environment, adds the corresponding dataset to the right of the cursor-dataset. In this current example, the cursor-dataset is Dataset-A (1701), and Dataset-A (1701) is shared with User-4. Therefore, in step 2034, The corresponding dataset, Dataset-A-1 (1762), is added to the right of Dataset-A (1701). Step 2036 loops back to step 2002 to add descendants for Dataset-A-1 (1762, which is now the cursor). Since User-4 has used the shared Dataset-A-1 (1762) to create new Dataset-M (1764). In steps 2002, 2010, 2012, 2014, Dataset-M (1764) would be found, and would be added to the right of Dataset-A-1 (1762).

In step 2050, where Data Lineage Service (1540) checks if the cursor-dataset (Dataset-A, 1701) has publications. If YES, in steps 2052 and 2060 Data Lineage Service (1540) iterates the publication one at a time. For each publication (published dataset), in steps 2054, 2056, and 2058, Data Lineage Service (1540) iterates the subscriptions. Using FIG. 7 as example, Dataset-A (1701) is published and has two subscribers, User-5 and User-6. In step 2054, the subscription Dataset-A-2 (1766) from subscriber User-5 is added to the right of Dataset-A (1701), and subscription Dataset-A-3 (1768) from subscriber User-6 is also added to the right of Dataset-A (1701). In step 2056, for each of these two subscriptions, Dataset-A-2 (1766) and Dataset-A-3 (1768), Data Lineage Service (1540) loops back to 2002 to find their descendants. In step 2056, to find descendant for Dataset-A-2 (1766), cursor-dataset is set to Dataset-A-2 (1766) before looping back to 2002. Since subscriber User-5 does not do anything to Dataset-A-2 (1766), there is no descendant. In step 2056, to find descendant for Dataset-A-3 (1768), cursor-dataset is set to Dataset-A-3 (1768) before looping back to 2002. Subscriber User-6 has used Dataset-A-3 (1768) to create a new dataset, Dataset-N (177). This new dataset, Dataset-N (1770) is found through steps 2010, 2012, and 2014, and Dataset-N (1770) is added to the right of Dataset-A-3 (1768).

After iterating through the processes in FIG. 19 and FIG. 20, the entire Lineage Map for Dataset-A is completely built at 1810.

### D.1.2. Project Container

FIG. 21 shows the current embodiment of the system components of a Project Container object. A typical Project Container object (2102) consists of a Collaborator Management service (2110), a Project Container Manager (2115), a Job Management service (2150), and one or more dataset objects (2120). In a Project Container object (2102) there can also be programs (2130), process pipelines (2140), and jobs.

FIG. 3, a sample Data User Environment, shows several Project Container objects (0340-a, 0340-b, 0340-x, 0340-y, etc.). In the example, both 0340-a and 0340-b are owned by user 0312-a. 0340-x is owned by user 0312-c. 0340-y is owned by 0312-d.

FIG. 22 illustrates the process (2202) in Project Container Collaborator Management service (2110) for adding a collaborator to a Project Container (2102). In step 2204, Container Collaborator Management service (2110) checks if all the datasets (2120) in the Project Container (2102) are share-able. If at least of the datasets (2120) is not share-able, collaborator cannot be added (2220). If all datasets (2120) are share-able, in step 2206, user provides collaborator information, Project Container Collaborator Management service (2110) locates the collaborator's user environment. In step 2208, user sets permission for the collaborator to use the Project Container (2102). The permissions include whether or not the collaborator can edit the metadata of the Project Container (2102); whether or not the collaborator can edit data content of the datasets; whether or not the collaborator can edit the programs (2030), processing pipelines (2140), and jobs (2052); and whether or not the collaborator can execute the jobs (2152). In step 2210, the collaborator is added to the Project Container (2102). In step 2212, the Project Container (2102) is added to the collaborator's user environment. Steps 2214 and 2218 Container Collaborator Management service (2110) iterates through all the datasets (2120) in the Project Container (2102) and adds the collaborator to each and every one of the datasets (2120) by calling the process 0860 in FIG. 8B. Note that this is only one of the embodiments, in this illustration, the removing of collaborator is not shown.

FIG. 23 illustrates an embodiment of Project Container Manager service (2115) (step 2302). In this illustration (step 2304), Project Container Manager service (2115), manages Project Container metadata (e.g., FIG. 6G) 2116, add or remove dataset(s) (2120) 2117, supports the uploading or selection of programs (2130) 2118, and manages processing pipelines (2140) 2119. In step 2310, Project Container Manager service (2115) manages the editing of Project Container metadata (e.g., FIG. 6G). In step 2320, Project Container Manager service (2115) adds a new dataset to (2120) the Project Container (2102). In steps 2322 and 2326, the Project Container Manager service (2115) iterates through the collaborators in the Project Container (2102), and in step 2324, the Project Container Manager service (2115) adds the collaborators to the new dataset using the process illustrated in FIG. 8B. Step 2330 is to remove an existing dataset (2120) from the Project Container (2102). In step 2340, Project Container Manager service (2115) receives a reference to a program and uploads the program (2130) to the Project Container (2002). A reference of a program identifies the location of the program, it can be an address, a unique identifier, or a name. Alternatively, Project Container Manager service (2115) allows an existing (uploaded) program to be selected for use in the Project Container (2102). In step 2350, Project Container Manager service (2115) allows user to use existing tools in the system to build or to edit a processing pipeline. Once there are datasets (2120), program (2130), and/or processing pipeline (2140), the Job Management service (2150) of the Project Container (2102) allows jobs (2152) to be built. A job (2152) includes one or more programs (2130-a, 2230-b) or pipelines (2140-c), one or more input datasets (2120-a, b), and one or more output datasets (2120-x, y, z). Once a job is built, it can be executed to generate report or new data (2120-x, y, z).

### D.2 Data Sharing Directory Service

FIG. 4 is an embodiment of the system components of Data Sharing Directory Service (0410) subsystem in the embodiments of the present disclosure. Data Sharing Directory Service (0410) is managed by Catalog Administrator (0202, see FIG. 2) and used by Data Users (0203-a, 0203-b, 0203-c, see FIG. 2). A Data User (0203-a, 0203-b, 0203-c) can be both a data publisher (owner) and a data subscriber (consumer). All system resources, such as Dynamic Data Catalog (0420) are recorded and saved as logical objects and are managed by Data Sharing Directory Service (0410).

Catalog Administrator (0202) can create one or more Dynamic Data Catalogs (0420) through Data Sharing Directory Service (0410). Within a catalog, Catalog Administrator (0202) can create Categories (0422) and add tags or keywords to the categories. Each Dynamic Data Catalog (0420) has a Data Publishing Service.

Data Users (0203-a, 0203-b, 0203-c; 0428) can publish their Datasets (0330-a, 0330-b) to one or more Catalogs (0420) in one or more Categories (0422) to share with an unknown number of subscribers. FIG. 9 illustrates an embodiment of the publishing process. In step 0900, a Data User (0203-a, 0203-b, or 0203-c; 0428) first selects a registered Dataset (0330-a, 0330-b, 0330-c, or 0330-z, see FIG. 3) to publish. In 0902, Data User Environment Object (0312) verifies whether the selected dataset is publish-able. If a dataset is a subscribed dataset or shared by another data owner, then the data owner may not allow the dataset to be published by a subscriber or a collaborator. Once Data User Environment Object (0312) verifies that the selected dataset is publish-able, in step 0904, the Data User (0203-a, 0203-b, 0203-c; 0428) selects a Dynamic Data Catalog (0420) for the publication. Then in step 0906, the Data User (0203-a, 0203-b, 0203-c; 0428) selects one or more categories in which to publish the dataset. In step 0907, the Data User (0203-a, 0203-b, 0203-c; 0428) may select to publish the whole data content of the dataset or partial data content. In step 0908, the Data User (0203-a, 0203-b, 0203-c; 0428) provides metadata for publishing the dataset. After that, in step 0910, the data user defines role-based security and privacy access control rules. Role-based security and privacy access control rules would restrict, according to a subscriber's role, what the subscriber can see in the dataset. The rules can involve the masking of some data, the transformation of some information (e.g., from a code to a name string), the denial of access based on time frame criteria, the prohibition of publication of derived data, etc. Next, in step 0912, the data user defines a subscription approval process. Subscription approval process specifies the order and which individual or what managing roles must approve of a subscription request. For example, the data owner may specify that the subscription requester's manager, the catalog manager, the data owner, and data owner's manager must all approve of the request before the subscription is allowed. Finally, in step 0914, the data publisher submits reference to the dataset, reference to the data content, reference to the catalog and the metadata package (Published Dataset Package 0426) to the Sharing Directory Service (0410) which then forwards the package to the Data Publishing Service (0420) to publish the dataset in the Catalog(s) (0420). A reference of a dataset may be an address, a pointer, an identifier, a label or a unique name of the dataset. A reference of a data content specifies the location of the portion of the content in a dataset. A reference of a catalog may be a pointer, an identifier, a label, an address, or a name of the catalog.

Once the Datasets (0426) are published in Dynamic Data Catalogs (0420), data users can browse 0262 the categories and select Published Datasets (0426) for subscription. FIG. 10 illustrates an embodiment of a subscription process. Once a published dataset has been selected for subscription (1000), in step 1002, the data user issues a Subscription Request (0263, see FIG. 2) with a reference to the selected published dataset to the Subscription Service (0430), which then retrieves the Published Dataset (0426) following the subscription approval process as defined in step 0912 of the publication process. A reference of a published dataset may be a unique name, an address, a pointer, or an identifier. In step 1004, the Subscription Service (0430) sends subscription Approval Requests (0265) to the appropriate individuals for approval. If and when all positive responses have been received in step 1006, in step 1012, the Subscription Service (0430) adds the data user (subscriber 0434-a) to the Subscription object (0432), which tracks all Subscribers (0434) for the specific Published Dataset (0426). Each Subscriber (0434-a) is linked to his/her specific Data User Environment (0312-a, see FIG. 3). The Subscription Service (0430) then creates a Subscribed Data Item (0328-c) into the Data User's Environment (0312-a) within the subscriber's Subscription list (0326). As shown in 1014, the Subscribed Data Item (0328-c) is linked to the Published Dataset (0426) and the Subscriber (0434-a). The Subscribed Data Item (0328-c) is also linked to the original Dataset (0330-a, or 0330-b) belonging to the data owner through the Published Dataset (0426). The Subscribed Data Item (0328-c) appears in the subscriber user environment under Subscription (0326). The subscriber, in his/her Data User Environment (0312-a), can then register the Subscribed Dataset (0330-c) to be used in his/her Project Containers (1016). Alternatively, the system according to embodiments of the present disclosure can automatically register the Subscribed Dataset (0330-c) without having user manually taking action.

### D.3 Virtual Data Service

FIG. 5 is an embodiment of the system components of Virtual Data Service (see 0240 FIG. 2, 0510 FIG. 5). This diagram illustrates how datasets from different data sources are accessed by a data users' Application Projects (0511-a, 0511-b, 0511-c). Note that Application Projects (0511-a, 0511-b, 0511-c) include data users' applications (0213-a, 0213-b, 0213-c and programs in Project Containers 0223-a, 0223-b, 0223-c).

In the embodiments of the present disclosure, Datasets (0390, FIG. 3) come from three different sources:

Datasets that are owned (0330-a, 0330-b, see FIG. 3) by the user and registered from the user's Home (0321, FIG. 3) or the user's Corporate Data Servers (0324, see FIG. 3); [0132] Subscribed Datasets (0330-c, FIG. 3) that the user subscribed from Dynamic Data Catalog (0420);

Shared Datasets (0330-z, see FIG. 3) is a shared with the current user by a Collaborator (0312-c, FIG. 3).

In this embodiment, all data access goes through a Virtual Dataset Access Interface Service (0512). In an alternative embodiment, only selected data access may go through Virtual Dataset Access Interface Service (0512). The example in FIG. 3 and FIG. 5 shows the Data User's (0312-a) Application Project (0511-a) accesses Dataset (0330-c), which is a Subscribed Data Item (0328-c); the Data User's (0312-a) Application Project (0511-b) accesses Dataset (0330-a or 0330-b), which are datasets directly owned by the User (0312-a); Data User's (0312-c) Application Project (0511-c) access the Dataset (0330-x) which is a dataset shared with Data User (0312-c) by Data User (0312-a).

When Data Users (0312-a, 0312-c) access Datasets (0330-a/0330-b, 0330-c, 0330-x), these datasets contact Virtual Dataset Access Interface service (0512). Then Virtual Dataset Service (0510, also 0240 as shown in FIG. 2) creates corresponding Virtual Dataset (0515-a . . . e) to provide data access middleware service to the user's Application Projects (0511-a, 0511-b, 0511-c). In this embodiment, Virtual Dataset Service (0240, 0510) creates and manages all the Virtual Dataset (0516-a . . . e).

FIG. 11 illustrates an embodiment of the process to initiate the access of a dataset. In step 1100, the data user's Application Project (0511-a, 0511-b, 0511-c) initiates an access to a dataset. If the process is completed successfully, a virtual dataset handle is given to the Application Project (0511-a, 0511-b, 0511-c) where the data can be accessed (READ or WRITE) through the handle. The READ and WRITE data access are illustrated in FIGS. 12A-12B.

When the Data User's (0312-a) Application Project (0511-a) initiates access to a Dataset (0330-c, see FIG. 3) as shown in step 0514 of FIG. 5, the process begins in step 1100. In step 1101, the Dataset (0330-c) connects to Virtual Dataset Access Interface Service (0512). In step 1102, Virtual Dataset Access Interface Service (0512) determines that Dataset (0330-c) is a Subscribed dataset that is linked to a subscribed Data Item (0328-c). In step 1112, Virtual Dataset Access Interface Service (0512) locates the associated Published Dataset (0426 FIG. 4, 0515 FIG. 5) through Subscribed Data Item (0328-c). Then in step 1114, according to the Subscriber's (data access user) role, Virtual Dataset Service (0510) extracts the specific role-based security & privacy rules, as defined by the data owner (in FIG. 9, 0910) for the Published Dataset (0426, FIG. 4). In step 1116, Virtual Dataset Service (0510) creates a Virtual Dataset (0516-a). Virtual Dataset (0516-a) converts the specific security & privacy rules into data transformation logic and loads the logic into itself. Then in step 1118, Virtual Dataset Service (0510) finds the original Dataset (0330-a or 0330-b, see 0517), sets Dataset-A to the original Dataset (0330-a or 0330-b, see 0517) and goes to step 1131 to open the actual Dataset (0330-a or 0330-b, see 0517). The actual dataset handle is finally saved into the Virtual Dataset (0516-a) in step 1141.

When Data User's (0312-c) Application Project (0511-c) initiates access to a Dataset (0330-x, see FIG. 3) as shown in step 0520 in FIG. 5, the process begins in step 1100. In step 1101, the Dataset (0330-x) connects to Virtual Dataset Access Interface Service (0512). In step 1102, Virtual Dataset Access Interface Service (0512) determines that Dataset (0330-x) is a shared dataset linked to Dataset (0330-a or 0330-b, see 0522). This Dataset (0330-x) is shared by another data user who collaborates with the current User (0312-c). In step 1162, Virtual Dataset Service (0510) locates the original dataset (0330-a or 0330-b, and 0522, see FIG. 3 and FIG. 5). In step 1164, Virtual Dataset Service (0510) extracts the specific security & privacy rules (0360-x, FIG. 3) that the data owner defined for the collaborator sharing the original Dataset (0330-a or 0330-b), see FIG. 3. In step 1166, Virtual Dataset Service (0510) creates a Virtual Dataset (0516-e). Virtual Dataset (0516-e) converts the specific security and privacy rules into data transformation logic, then loads the logic into itself. In step 1168, Virtual Dataset Service (0510) sets Dataset-A to the original Dataset (0330-a or 0330-b, see 0522) and goes to step 1131 to open the actual Dataset (0330-a or 0330-b, see 0522). The actual dataset handle is saved into the Virtual Dataset (0516-e) in step 1141.

When Data User's (0312-a) Application Project (0511-b) initiate access to a Dataset (0330-a or 0330-b, see FIG. 3) as shown in step 0530 in FIG. 5, the process begins in step 1100. In step 1101, the Dataset (0330-a or 0330-b) connects to Virtual Dataset Access Interface Service (0512). In step 1102, Virtual Dataset Access Interface Service (0512) determines that Dataset (0330-a or 0330-b) is directly owned by the Data User (0312-a), then Virtual Dataset Service (0510) creates a Virtual Dataset (0516-d) in step 1130.

All Virtual datasets (0516-a, 0516-d, and 0516-e) go over the same path starting at step 1131 to open the actual data item. The process begins in step 1131. As mentioned in earlier sections, Virtual Datasets 0516-a and 0516-e both include a data transformation logic to enforce security and privacy access control rules. The data transformation logic in 0516-a would transform data according to the role-based security and privacy control rules, as defined by the publisher for the specific subscriber's role, before sending data to the data user (i.e., the subscriber 0312-a, see FIG. 5). While the data transformation logic in 0516-e would transform data according to the security and privacy access control rules defined by the data owner who shares the dataset with the current user (i.e., the collaborator 0312-c, see FIG. 5) before sending data to the data user (i.e., the collaborator 0312-c), Virtual dataset (0516-d) does not include data transformation logic.

In step 1131, Virtual dataset (0516-a, 0516-d, or 0516-e) tests the dataset's source. If the dataset's source is a Home directory (see FIG. 3, 0321, in which case, the Dataset is 0330-a), in step 1132, the Virtual dataset (0516-a, 0516-d, or 0516-e) connects to the Home directory (see FIG. 3, 0321). If the dataset's source is a Data Server (see FIG. 3, 0324), in step 1134, the Virtual dataset (0516-a, 0516-d, or 0516-e) connects to the associated Data Server (0324) through the Connector (0323). In step 1136, the Virtual Dataset (0516-a, 0516-d, or 0516-e) checks the data type, which can be a file (or object) or a database table. If the Dataset (0330-a or 0330-b) is a file or a file object, in step 1138, the Virtual Dataset (0516-a, 0516-d, or 0516-e) opens the associated file or file Data Item (0328-a, 0328b) and obtains a file handle. If the Dataset (0330-b) is a database table, then in step 1140, the Virtual Dataset (0516-a, 0516-d, or 0516-e) creates a handle, locates the related data table Item (0328-b), and associates the database table with the handle. In step 1141, the Virtual Dataset (0516-a, 0516-d, or 0516-e) saves the file or database table handle.

Once the Virtual Dataset (0516-a, 0516-d, and 0516-e) is established, as shown in FIG. 5, the Virtual Dataset (0516-a, 0516-d, and 0516-e) is now ready to handle access requests (READ or WRITE) from the user's Application Projects (0511-a, 0511-b, 0511-c, see FIG. 5).

FIG. 12A illustrates a process for accessing a subscribed or shared dataset according to embodiments of the present disclosure after a Virtual Dataset (see 0516-a and 1116, 0516-e and 1166, in FIGS. 5 and 11) is created. As shown in FIG. 11, in step 1116, Virtual Dataset (0516-a) is created for accessing a subscribed dataset; and in step 1166, Virtual Dataset (0516-e) is created for accessing a shared dataset (shared by another data user with the current user). In step 1200a, the user Application Project (0511-a, 0511-c, see FIG. 5) issues a READ or WRITE data access request to Dataset (0330-c or 0330-x, see FIG. 5). In step 1202a, Dataset (0330-c or 0330-x, see FIG. 5) then issues a READ or WRITE data access request to Virtual Dataset (0516-a or 0516-e). In step 1204a, Virtual Dataset (0516-a or 0516-e) issues a READ or WRITE request to the file or database table for which the handle was obtained from step 1141. If the request is a READ (see step 1206a, 1208a), after obtaining the data from step 1204a, Virtual Dataset (0516-a or 0516-e) transforms the data using the security and privacy access control logic (loaded in 1116 or 1166) before sending the result back to the application project in step 1210a. If the request is a WRITE (see steps 1206a, 1212a), the result is sent back to the application project.

FIG. 12B illustrates a process for accessing directly-owned dataset according to embodiments of the present disclosure after a Virtual Dataset object (0516-d in FIG. 5, 1130 in FIG. 11) is created. In step 1230b, User Application Project (0511-b, see FIG. 5) issues a READ or WRITE data access request to dataset (0330-a or 0330-b, FIG. 5). In step 1232b, Dataset (0330-a or 0330-b) issues the same request to the Virtual Dataset (0516-d) using the Virtual Dataset (0516-d) handle obtained from step 1100. In step 1234b, Virtual Dataset (0516-d) issues a READ or WRITE request to the file or database table in accordance with the file or database handle obtained from step 1141. The result is returned to the application project (0511-b).

### D.3.1 Sample Data Objects

FIGS. 6A-6I show several sample system data objects according to embodiments of the present disclosure. Data objects are for managing resources (such as data servers, files, tables, projects, jobs, etc.) and the usage of the resources. The information as shown in these sample data objects is simply one of their possible embodiments. The information in each of the sample objects may be a subset of the necessary information for a similar data object. Also, some information in the sample objects may be redundant. In a different embodiment, some data objects may be grouped as one, or one data object may be split into multiple objects.

FIG. 6A is a sample Corporate Data Connector object (0323, see FIG. 3). It contains connection information to corporate data servers (0324), such as database servers, document servers, application data servers, etc. As shown in FIG. 6A, a sample Corporate Data Connector object (0323) contains data server type, server address and port, and data owner. Data server type indicates if the server is a database or a file server. Server address and port allow Data User Environment (0312) to make connection to a data server. Data owner credential enables the Data User Environment (0312) to establish a trusted connection with the data server. Corporate Data Connector object (0323, see FIG. 3) allows the Data User Environment (0312) to use a proper data server protocol while connecting and communicating with the data server.

FIG. 6B is a sample Data Server Object (0324, see FIG. 3). It contains information for managing the usage of a corporate data server, which can be a database server or a file/object server. In an alternative embodiment, a Data Server Object (0324, FIG. 3) can combine with its associated Corporate Data Connector (0323) object. As shown in FIG. 6B, a sample Data Server object contains an association to a Corporate Data Connector, a data source name (such as a directory or a database name), metadata associated with the data server (e.g., owner identity, security classification, properties, and attributes), usage control policies, and a list of registered Data Items (0328-b; files or tables). If a Data Server (0324) is classified as secured, for example, the data server owner may wish to set usage control policies such as restricting the data from being downloaded, and/or configure a specific location for storing derived datasets. A database server can have tens to hundreds of tables, and a file server can have hundreds to millions of files. When a data user selects and registers (see FIG. 8 for the process to register a dataset) one or more tables or files for processing, those tables or files are tracked as registered Data Items (0328-b, FIG. 3).

FIG. 6C is a sample Data File object (0328-a, FIG. 3) associated with the Home connector (0321, FIG. 3). Home (0321) is a connector to a personal online file store where a data user can upload and store personal files (0328-a). When an uploaded personal file (0328-a, FIG. 3) is registered as a dataset (0330-a, FIG. 3) for use in a project, the personal file is tracked as a registered Dataset (0330-a). As shown in FIG. 6C, a sample Data File Object contains an association to the Home connector (0321), a unique data item ID, a file path name which is a link to the actual file, file content format (file type), schema, registration date and registered dataset ID (Dataset 0330-a), if the file is registered for analytical use. The registered dataset ID associates the Data Item (0328-a) with a registered Dataset object (0330-a, see FIG. 3).

FIG. 6D is a sample Data File or Table object (0328-b, FIG. 3) associated with a corporate Data Server (0324, FIG. 3). When a data user selects and registers a data item from a Data Server (0324), the Data Item (0328-b) is tracked as a registered Dataset (0328-a, FIG. 3). As shown in FIG. 6d, a Registered Data Item (file or table) object (0328-b) contains an association to its corresponding Data Server (0324), a unique data object ID, its type (file or table), a data item name (which links to the actual data item), schema, registration date and the registered dataset ID (0330-b, see FIG. 3), if the file or table (0328-b, FIG. 3) is registered for analytical use.

FIG. 6E is a sample Subscribed Data Item (0328-c, FIG. 3), consisting of a dataset to which the current user has subscribed from a Dynamic Data Catalog (0233 FIG. 2, or 0420 FIG. 4). Data users can publish their Dataset (Published Dataset 0426 see FIG. 4) for sharing, and other data users can subscribe to these datasets. The process to publish a dataset is illustrated in FIG. 9, and the process to subscribe to a dataset is illustrated in FIG. 10. In a Data User Environment (0312, FIG. 3), Subscribed Data Items (0328-c) are grouped under Subscription (0326, FIG. 3). A Subscribed Data Item (0328-c, FIG. 3) contains a unique Data ID, an association to the user's Subscription object (0326, 0432), a reference to the Published Dataset (0426), the catalog and category of the publication, data type, schema, metadata, and registration date and the associated registered dataset ID (0330-c, see FIG. 3), if the data item is registered.

FIG. 6F is a sample Registered Dataset (0330-a, b, c, z, see FIG. 3). Registered Datasets (0330-a, b, c, z) are a managed data list selected by data users to perform data processing and analysis. A Registered Dataset (0330-a, b, c, z) can be a user's personal data file (0328-a) chosen from Home (0321), or corporate Data Item (0328-b) chosen from Data Server (0324), or dataset shared by other Collaborators (0330-y), or Subscribed Data Item (0328-c) from Dynamic Data Catalog (0420). The process to register a dataset is shown in FIG. 8. As shown in FIG. 6F, a Registered Dataset consists of a link to its Data User Environment object (0312), a Data ID which links to the actual data item (Data ID), a registered dataset name and ID, the registration date, data type, schema, metadata, data lineage, data profile, subscription, collaboration (Shared-With-Me, and Shared-By-Me), and publication information. If a Registered Dataset is a Subscribed Data Item (0328-c), it is associated with a Subscription object (0326, 0432) by the Subscription ID. If a Registered Dataset is shared with the current user by a collaborator, the Registered Dataset object would contain Shared-with-Me information, which includes the identity of the collaborator, the original dataset ID (0330-y), the access permission (Read/Write on metadata and data) granted by the owner, and the data access security and privacy control rules as defined by the owner. The current user can also share his/her dataset with other data users by adding collaborators. When the current data user adds a collaborator, a Shared-By-Me entry is created to allow the user to enter information about the collaborator, change access permission (Read/Write on metadata and data), and set data access security and privacy control rules. The current data user can publish a Registered Dataset (0330-a, 0330-b) in a catalog to share with an indefinite number of data users. If a Registered Dataset (0330-a, 0330-b) is published, the associated Dynamic Data Catalog (0420), the category (0422), the publication ID, metadata, and role-based security and privacy access control rules, as well as a subscription approval process are provided by the user and captured in the Registered Dataset object.

FIG. 6G is a sample Project Container object (0340, FIG. 3). A Project Container object (0340, FIG. 3) is a container where datasets uses by the project, and other resources are managed, and where the data user can create programs (0344, FIG. 3) or assemble Data Processing Tools (0346, FIG. 3) to process and analyze data. A data user can create Project Containers (0340-a, 0340-b, . . . ) in his/her Environment (0312-a), add one or more registered Datasets (from 0330-a, 0330-b, 0330-c, 0330-z) to the Project Container, create Programs (0344, FIG. 3) or assemble Data Processing Tools (0346, FIG. 3) into data processing pipelines, and schedule programs or data processing pipelines to execute as Jobs. Jobs can also be triggered to run manually, in real-time, or via a preset schedule. A Project Container object manages job scheduling and execution, and track execution history and results. A Project Container object is linked to its Data User Environment (0312), and contains a project ID, a project name, the dates of its creation and updates, metadata, registered Datasets (0330-a, b, c, z), data pipelines and programs, jobs, job scheduling, and execution history and results.

FIG. 6H is a sample Published Dataset (0426, FIG. 4). A data user can publish his/her own Datasets (0328-a or 0328-b, FIG. 3) in a Dynamic Data Catalog (0420, FIG. 4) to share with an indeterminate number of data users. Other data users can browse or search a Catalog (0420, FIG. 4) and subscribe to a Published Dataset (0426, FIG. 4). The process to publish a dataset is illustrated in FIG. 9, which is described in the Data Sharing Directory Service section. A published Dataset (0426, FIG. 4) contains a publication ID and publication name, the associated registered dataset ID and name (0428, FIG. 4), the Catalog (0420, FIG. 4) and Category (0422, FIG. 4) where the data is published, metadata (such as owner's info, properties, keywords, etc.), role-based security and privacy access control rules (as shown in FIG. 6I), the subscription approval process as defined by the data owner/publisher, and a list of subscribers (subscriber ID, role, subscribed data item, and subscription date).

FIG. 6I is a sample role-based security and privacy access control rules object. The object contains some sample rules. For example: Rule-1 is a set of masking rules, using which the data owner can define which data fields to mask for which user role; Rule-2 is a set of Transformation rules, which contain functions to transform some data fields for specific user roles; Rule-3 contains a set of rules for filtering out some data for specific user roles. Rule-4 contains a set of rules to restrict data publication for specific user roles; Rule-5 contains a list of rules to set time constraints for specific user roles, etc. When a data user tries to access a Published Dataset (0426, FIG. 4), he/she first connects to the Published Dataset (0426, FIG. 4) through a process as illustrated in FIG. 11. Once the connection is established, the Published Dataset (0426, FIG. 4) can be accessed through a process illustrated in FIG. 12A. The role-based security and privacy access control rules for the data user are enforced by the Virtual Dataset (0516-a).

### D.4 Recursive Production of New Datasets Through the Combination of Novel and Shared Data

FIG. 13 depicts the scenario according to an embodiment of the present disclosure whereby data users securely share their data with one another through a publication and subscription process. As shown in FIG. 13, personalized and role-based secured access of shared data is enforced through Virtual Dataset Objects which are instantiated (created) spontaneously upon data access.

FIG. 13 is similar to FIG. 2 but with more details on secured inter-sharing of the data. For example, Data Users (1301-a, 1301-b, and 1301-c) in FIG. 13, are similar to Data Users (0203-a, 0203-b, 0203-c). Data User Environments (1302-a, 1302-b, 1302-c) are depicted as 0221-a, 0221-b, and 0221-c in FIG. 2. Data Sharing Directory (1304) is 0230 in FIG. 2. Virtual Dataset Service environment (1305) is 0240.

User Application Projects (1303-a, 1303-b, 1303-c, in FIG. 13) access (1350-a, 1350-b, 1350-c) their users' Datasets (0222-a, 0222-b, 0222-c, in FIG. 13) respectively in the Data User Environment (1302-a, 1302-b, 1302-c). Note that Application Projects (0511-a, 0511-b, 0511-c) include data users' applications (0213-a,b,c and programs in Project Containers 0223-a,b,c). User Application Projects (1303-a, 1303-b, 1303-c, in FIG. 13) read the Datasets (0222-a, 0222-b, 0222-c, in FIG. 13) and may create new data into existing Datasets or new Datasets (0222-a, 0222-b, 0222-c, in FIG. 13) in Data User Environment (1302-a, 1302-b, 1302-c).

Dataset (0222-a, 0222-b, or 0222-c, in FIG. 13) in Data User Environment (1302-a, 1302-b, 1302-c) is also depicted as Dataset group (0390) in FIG. 3, within 0390 there are Datasets 0330-a, 0330-b, 0330-c, and 0330-z. As disclosed in FIG. 3, some of a user's Datasets may be owned by the user (such as 0330-a and 0330-b); some Datasets (such as 0330-z) may be shared directly with the user by a collaborator; while still other Datasets (such as 0330-c) may come from the user's subscription through a Dynamic Data Catalog. FIGS. 8A-8B illustrate a process according to embodiments of the present disclosure by which self-owned datasets (personal and corporate data), subscribed datasets and directly shared datasets (through collaboration, see 0826, 0828, 0829) are registered into Data User Environment (1302-a, 1302-b, 1302-c). For subscribed datasets, role-based security and privacy access control is defined by the data owner through the data publishing process. For direct data sharing through collaboration, personalized security and privacy access control is defined by the data owner when he/she adds collaborators.

FIG. 13 shows that Data User (0203-a, FIG. 13) may publish (1310-a) one or more Datasets (0222-a, FIG. 13) into a Dynamic Data Catalog (0233, FIG. 13). During publication, the Data User (0203-a, FIG. 13) must define role-based security and privacy access control rules for the subscribers. The user can also define the Subscription Approval

Process. A publication process according to embodiments of the present disclosure is illustrated in FIG. 9. Similarly, Data Users (0203-b, 0203-c, FIG. 13) may publish (1310-b, 1310-c) their Datasets (0222-b, 0222-c, FIG. 13). The published Datasets can include Datasets that are created by Application Projects (1303-a, 1303-b, 1303-c, FIG. 13) that combine user's own datasets, shared datasets, and/or subscribed datasets.

FIG. 13 also shows that Datasets (0222-a, 0222-b, 0222-c, FIG. 3) from Data Users (0203-a, 0203-b, 0203-c, FIG. 13) may include datasets to which the users had Subscribed (1320-a, 1320-b, 1320-c) from a Dynamic Data Catalog (0233, FIG. 13). A subscription process according to embodiments of the present disclosure is illustrated in FIG. 10. A dataset subscription includes a set of owner-defined role-based security and privacy access control rules. Different user roles may see different data in accordance with these rules. Once the subscription process is completed, a Data User (0203-a, 0203-b, 0203-c, FIG. 13) can register the subscription in his/her environment (FIG. 8).

As shown In FIG. 2 and FIG. 13, Data Users (0203-a, 0203-b, 0203-c, FIG. 13) may collaborate by sharing (0213) their Datasets directly with collaborators. The direct sharing of Datasets (0330-a, 0330-b, 0330-x, 0330-y, 0330-z) through collaboration is also shown in FIG. 3. Data owners define personalized security and privacy access control rules for their collaborators, see FIG. 8.

When Data Users (0203-a, 0203-b, 0203-c, FIG. 13) share their data either through direct data sharing or through the publication and subscription process, they may define personalized (for direct sharing) and role-based security and privacy access control rules for data subscribers and collaborators, respectively. By executing and enforcing the personalized and role-based security and privacy access control rules, data subscribers and collaborators accessing a shared dataset may see different information. When an Application Project (1303-a, 1303-b, 1303-c, FIG. 13) initiates a connection to one of the user's Datasets (0222-a, 0222-b, 0222-c, FIG. 13), Dataset (0222-a, 0222-b, 0222-c, FIG. 13) object goes through a process illustrated in FIG. 11 to spontaneously instantiate (create) a Virtual Dataset (0235, FIG. 5) and loads into the Virtual Dataset (0235) the personalized and role-based security and privacy access control rules according to the role of the user accessing the data (i.e., the project owner). As Application Project (1303-a, 1303-b, 1303-c, FIG. 13) accesses data through Dataset (0222-a, 0222-b, 0222-c, FIG. 13), the actual data access is performed by Virtual Dataset (0235, FIG. 13). As a data user's Application Project (1303-a, 1303-b, 1303-c, FIG. 13) accesses data, the corresponding Virtual Dataset (0235, FIG. 13) accesses the actual data, applies data transformation logic according to the personalized or role-based security and access control rules, then forwards the transformed data (1330-a, 1330-b, 1330-c) back to Application Project (1303-a, 1303-b, 1303-c, FIG. 13) through the corresponding Dataset (0222-a, 0222-b, 0222-c, FIG. 13). The data access processes are illustrated in FIGS. 12A-12B.

New Datasets (0222-a, 0222-b, 0222-c) can be created by Application Projects (1303-a, 1303-b, 1303-c) through combining information from multiple datasets, which include shared datasets, subscribed datasets, and datasets owned by the users themselves. New Datasets (0222-a, 0222-b, 0222-c) created by Application Projects (1303-a, 1303-b, 1303-c) can then be published (1310-a, 1310-b, 1310-c) into a Dynamic Data Catalog (0233, FIG. 13) as long as publication is allowed by the role-based security and privacy access control rules. By providing a mechanism, as offered by the embodiments of the present disclosure, through which data owners can regulate the access of their shared data according to user roles and collaborator status, new data can be produced recursively as shared and subscribed datasets are combined with user's self-owned data. FIG. 14 shows a process by which data users can inter-share their data while maintaining access control to their shared data according to embodiments of the present disclosure. By doing so, new datasets can be generated recursively and shared in turn.

FIG. 14 shows the effect of all the system components as illustrated in FIG. 3 (Data User Environment Service 0310, and Data User Environment Object 0312), FIG. 4 (Data Sharing Directory Service 0410, Data Publishing Service 0420, and Subscription Service 0430), and FIG. 5 (Virtual Dataset Access Interface Service 0512, and Virtual Dataset 0516) work together to achieve the recursive production of new datasets through continuous secured inter-sharing and processing of data.

In FIG. 14, 1401-a and 1401-b illustrate two different data users (User-A, and User-B) adding data servers (1402-a, 1402-b), selecting datasets from the servers, and registering the selected datasets (1403-a, 1404-a, 1403-b, 1404-b). The process, illustrated in FIG. 7 and FIG. 8 and is driven by Data User Environment Service 0310 and Data User Environment Object 0312, is repeatable as long as there are more data servers to be added and more datasets to be registered. Note that FIG. 14 illustrates only one aspect of the embodiments of the present disclosure. During data registration, the data users (User-A and User-B) can continue to add more data servers; a full scenario of the embodiments of the present disclosure is too complex to depict in a single flow diagram.

When there are one or more registered datasets, the users can choose to publish their datasets into a Dynamic Data Catalog (1405-a, 1405-b) through a process illustrated in FIG. 9 and is driven by the Data Sharing Directory Service 0410 and Data Publishing Service 0420. As part of the publication preparation, the users provide metadata, prepare role-based security and privacy access control rules, and define the subscription approval process. Lastly, the users submit their publications 1405-a, 1405-b) to the catalog.

The data users' (User-A and User-B) publications are available for subscription by other data users (1406-b to 1407-a, 1406-a to 1407-b) through a process illustrated in FIG. 10 and is driven by the Subscription Service 0430. A subscription can be added to any user's registered datasets (1407-a to 1404-a, 1407-b to 1404-b) through the Data User Environment Object 0312.

The users (User-A and User-B) can also collaborate with one another and share their datasets directly by defining personalized security and privacy access control rules (1415-a, and 1415-b); which is also illustrated in FIG. 8 through the process driven by Data User Environment Service 0310 and Data User Environment Object 0312. The directly-shared datasets are added to the collaborator's registered datasets (1415-a to 1404-b, 1415-b to 1404-a) through the Data User Environment Object 0312.

In 1408-a and 1408-b, a user's application project connects to one or more registered datasets to merge, clean, analyze, and create new datasets. The process to connect to each dataset is illustrated in FIG. 11 and is provided by the Virtual Dataset Access Interface Service 0512. Once connected, the application project reads and writes to the datasets (1409-a, 1409-b). The process of reading and writing to each dataset is illustrated in FIG. 12a and FIG. 12b and the service is provided by the Virtual Dataset 0516.

When the application projects generate new datasets, the new datasets are automatically registered (1410-a to 1404-a, 1410-b to 1404-b) through the Data User Environment Object 0312. If allowed by security and privacy access control rules, the new datasets can be published to a Dynamic Data Catalog (1405-a, 1405-b) through Data Publishing Service 0420, or shared with a collaborator (1415-a, 1415-b) through Data User Environment Service 0310. The process of adding registered datasets, then sharing and creating new datasets, is continuous and perpetual. Newly published datasets can be made available for subscription to other data users (through Subscription Service 0430), who can then combine them with their own datasets and other shared datasets to generate new datasets, which can in turn be published for sharing.

FIG. 14 illustrates only two users. In an actual scenario, many users can share their datasets with many other users simultaneously. By allowing data owners to collaborate directly with others or to share their data through individualized publication, where they have full control over personalized and role-based security and privacy access rules through the mechanism illustrated in FIG. 11, FIG. 12a, and FIG. 12b, the embodiments of the present disclosure supports the recursive production of new datasets through the combination of novel and shared data among data users.

Based on the above system and method, embodiments of the present disclosure also provides a computing device, which may include: one or more processors, one or more memories, and a communication bus configured to couple the one or more processors and the one or more memories; wherein the one or more memories store one or more instructions, and when executed by the one or more processors, the instructions cause the one or more processors to perform the above described method for inter-sharing of data among a plurality of data users.

Embodiments of the present disclosure also provide a non-transitory computer-readable storage medium, which may include one or more instructions, when executed by one or more processors, cause the one or more processors to perform the above described method for inter-sharing of data among a plurality of data users.

What is claimed is:

1. A user environment for a multi-user collaborative data governance system for one or more collaborators, comprising:
one or more data connectors;
one or more data catalogs;
one or more datasets; and
a user environment service implemented on one or more processors;
wherein the user environment service is configured to:
associate each of the one or more datasets with a data item from one of the one or more data connectors;
associate each of the one or more datasets with a subscribed data item subscribed from one of the one or more data catalogs;
associate each of the one or more datasets with a published dataset in one of the one or more data catalogs through publishing the dataset on the data catalog; and
associate each of the one or more collaborators with one or more datasets with usage permission.

2. The user environment of claim 1, wherein the user environment service is configured to:
receive a user request to register to the user environment a selected data item from the data connector or a selected subscribed data item subscribed from the data catalog;
create a dataset; and
associate the dataset with the data item.

3. The user environment of claim 2, wherein the user environment service is configured to:
associate the dataset with the data item from the data connector by linking the dataset to the data item; and
associate the dataset with the subscribed data item subscribed from the data catalog by linking the dataset to the subscribed data item.

4. The user environment of claim 3, further comprising:
a subscription service implemented on one or more processors and configured to:
receive a reference to a published dataset from the data catalog selected by a user,
create the subscribed data item in the user environment,
associate the subscribed data item with the published dataset by linking the subscribed data item with the published dataset, and
retrieve the published dataset subscription approval process,
send approval requests to appropriate users as indicated in the subscription approval process, and
receive approval responses before creating the subscribed data item in the user environment.

5. The user environment of claim 1, further comprising:
a publication service implemented on one or more processors and configured to: receive
a reference to the dataset selected by a user when publishing the dataset on the data catalog,
verify the dataset is publishable,
receive the reference to the data catalog and categories selected by the user,
receive the reference to the partial or the entire content in the dataset selected by the user to be published,
receive metadata provided by the user, and
present the selected dataset and provided information as a published dataset in the catalog under the selected categories.

6. The user environment of claim 5, wherein the metadata includes role-based security and privacy access control rules defined by the user or a subscription approval process defined by the user.

7. The user environment of claim 1, further comprising:
a collaboration service implemented on one or more processors and configured to:
receive a selected collaborator and a selected dataset,
add the selected collaborator to the selected dataset,
set the usage permission for the selected collaborator to use the selected dataset,
set personalized security and privacy access control rules for the selected collaborator to access content of the selected dataset,
create a new dataset in the selected collaborator user environment, and
link the new dataset to the selected dataset.

8. The user environment of claim 1, further comprising:
one or more project containers; and
a project container manager, configured to receive one or more datasets selected and associate each of the one or more datasets with a project container by adding the datasets to the project container.

9. The user environment of claim 8, wherein the project container manager is further configured to receive user instructions to create a data processing pipeline in the project container.

10. The user environment of claim 8, wherein the project container manager is further configured to:
receive a reference to a data processing program, if the data processing program does not exist in the system upload the data processing program into the project container or if the data processing program exists in the system add the data processing program to the project container, and
associate each of the one or more collaborators with a project container with usage permission.

11. The user environment of claim 10, wherein project container collaborator manager is configured to:
receive one or more selected collaborators,
associate the one or more selected collaborators with a project container by adding information on the one or more selected collaborators to the project container and adding the project container to the one or more selected collaborators user environment; and
for the one or more datasets associate with the project container, configure the collaboration service to add the one or more selected collaborators to the dataset.

12. The user environment of claim 1, further comprising: a data profile service implemented on one or more processors and configured to:
receive a data portion or a data field in the dataset selected to be inspected,
receive a data profile method selected,
execute the data profile method against the data portion or data field, and
generate a data profile result.

13. The user environment of claim 1, further comprising:
a data lineage service implemented on one or more processors and configured to:
receive the reference to a dataset, and
construct a data lineage map comprising one or more ancestor datasets of the dataset, and one or more descendant datasets of the dataset,
wherein the data content of the dataset is a derivative product of data contents of the one or more ancestors, and data contents of the descendant datasets are a derivative product consisting of the data content of the dataset.

14. The user environment of claim 1, wherein the user environment service is further configured to in response to a data access request initiated by a data user or an application of the data user to a dataset, obtain a virtual dataset from a virtual dataset service subsystem and return the virtual dataset to the data user or the application of the data user.

15. A multi-user collaborative data governance method implemented on one or more processors, comprising:
associating each of one or more datasets with a data item from one of one or more data connectors;
associating each of the one or more datasets with a subscribed data item subscribed from one of one or more data catalogs;
associating each of the one or more datasets with a published dataset in one of the one or more data catalogs through publishing the dataset on the data catalog; and
associating each of one or more collaborators with one or more datasets with usage permission.

16. The method of claim 15, further comprising:
receiving a user request to register to a user environment a selected data item from the data connector or a selected subscribed data item subscribed from the data catalog;
creating a dataset; and
associating the dataset with the data item.

17. The method of claim 15, further comprising:
receiving the reference to a published dataset from the catalog selected by a user;
creating the subscribed data item in a user environment of the user;
associating the subscribed data item with the published dataset by linking the subscribed data item with the published dataset;
retrieving the published dataset subscription approval process;
sending approval requests to the appropriate users as indicated in the process; and
receiving approval responses before creating the subscribed data item in the user environment.

18. The method of claim 15, further comprising:
receiving the reference to the dataset selected by a user when publishing the dataset on the data catalog;
verifying the dataset is publishable;
receiving the reference to the data catalog and categories selected by the user; receiving
the reference to the partial or the entire content in the dataset selected by the user to be published;
receiving metadata provided by the user; and
presenting the selected dataset and provided information as a published dataset in the catalog under the selected categories.

19. The method of claim 18, further comprising:
receiving information on a selected collaborator and a selected dataset;
adding information on the selected collaborator to the selected dataset;
setting the usage permission for the selected collaborator to use the selected dataset;
setting specific security and privacy access control rules for the selected collaborator to access content of the selected dataset;
creating a new dataset in the selected collaborator's user environment; and
linking the new dataset to the selected dataset.

20. The method of claim 15, further comprising:
receiving one or more datasets selected; and
associating each of the one or more datasets with a project container by adding the datasets to the project container;
receiving user instructions to create a data processing pipeline into the project container;
receiving the reference to a data processing program, if the data processing program does not exist in the system uploading the data processing program into the project container or if the data processing program exist in the system adding the data processing program to the project container; and
associating each of the one or more collaborators with a project container with usage permission.

21. The method of claim 20, further comprising:
receiving information on one or more selected collaborators; and
associating the one or more selected collaborators with a project container by adding information on the one or more selected collaborators to the project container; adding the project container to a user environment of the one or more selected collaborators; and for the one or more datasets associated with the project container, configuring the collaboration service to add the one or more selected collaborators to the dataset.

22. The method of claim 15, further comprising:
receiving a data portion or a data field in the dataset selected to be inspected;
receiving a data profile method selected;
executing the data profile method against the data portion or data field, and
generating a data profile result.

23. The method of claim 15, further comprising:
receiving the reference to a dataset; and
constructing a data lineage map comprises one or more ancestor datasets of the dataset, and one or more descendant datasets of the dataset; wherein the data content of the dataset is a derivative product of data contents of the one or more ancestors; and data contents of the descendant datasets are a derivative product consist of the data content of the dataset.

24. The method of claim 15, further comprising:
in response to a data access request initiated by a data user or an application of the data user to a dataset, obtaining a virtual dataset from a virtual dataset service sub-system; and returning the virtual dataset to the data user or the application of the data user.

25. A non-transitory computer-readable storage medium, comprising one or more instructions, when executed by one or more processors, cause the one or more processors to perform the multi-user collaborative data governance method according to claim 15.
